(19) United States
(12) Patent Application Publication
(10) Pub. No.: US 2026/0187680 A1
(43) Pub. Date: Jul. 2, 2026

(54) Content Generation Using Pre-Existing Media Assets Using Generative Machine Learning Models

(71) Applicant: Google LLC, Mountain View, CA (US)

(72) Inventors: Charles Baxter Boyd, Santa Clara, CA (US); Hunter Chang Young Ford, New York, NY (US); Nathan Christopher Kiraly, Milwaukee, WI (US)

(21) Appl. No.: 18/855,977

(22) PCT Filed: May 9, 2024
(86) PCT No.: PCT/US2024/028510

§ 371 Date: Oct. 10, 2024

Related U.S. Application Data
(60) Provisional application No. 63/501,191, filed on May 10, 2023.

(51) Int. Cl. G06Q 30/0241; G06T 5/77; G06T 11/00

(52) U.S. Cl. CPC G06Q 30/0276; G06T 5/77; G06T 11/00

(57) ABSTRACT

Example embodiments of the present disclosure provide for an example method including generating media assets based on a pre-existing media asset. The method includes extracting signals including background image data, color palette data, text data, or logo image data. The method includes generate back ground image assets, text assets, and unique profile data based on the extracted signals. The method includes transmitting the media assets to a content item generation pipeline to generate a number of new candidate content items.

### PRIORITY

The present application claims the benefit of priority of U.S. Provisional Patent Application No. 63/501,191, filed on May 10, 2023, which is incorporated by reference herein.

### FIELD

The present disclosure relates generally to automatically generating content items or media assets using generative machine-learned models based on a profile or preference of a user and existing media assets.

### BACKGROUND

A communication campaign can leverage a multi-modal, multi-platform distribution system to distribute content items to various endpoints for various audiences. The content items can contain data or other information or messages. The content items can be or include media assets. A user can create a communication campaign by providing the multi-modal, multi-platform distribution system with a set of content items for distribution.

### SUMMARY

Aspects and advantages of embodiments of the present disclosure will be set forth in part in the following description, or can be learned from the description, or can be learned through practice of the embodiments.

One example aspect of the present disclosure is directed to a computing system for generating content items. The computing system can include one or more processors and one or more non-transitory computer-readable media. The computer-readable media can collectively store a machine-learned generation model, a machine-learned selection model, and instructions. The machine-learned generation model can be configured to generate a plurality of content items. The machine-learned selection model can be configured to select a selected content item from the plurality of content items. The instructions, when executed by the one or more processors, cause the computing system to perform operations. The operations can include receiving data indicating a request for a plurality of media assets that comprise a plurality of media modalities to be generated based on a pre-existing media asset. The operations can include generating a plurality of media asset components by: (i) extracting, from the pre-existing media asset, one or more signals comprising at least one of background image data, color palette data, text data, or logo image data; (ii) generating, using a first generative machine-learned model, a plurality of background image assets by: generating, based on at least one of the background image data, the text data, or the logo image data, a mask image comprising one or more bounding boxes; inpainting the mask image by generating, using a machine-learned model, pixels to fill the one or more bounding boxes of the mask image; generating a plurality of images, wherein each image comprises distinct aspect ratio; (iii) generating, using a second generative machine-learned model, a plurality of text assets by: obtaining the text data associated with the one or more bounding boxes; inputting the text data into a machine-learned model; generating, by the machine-learned model a plurality of text assets as output; and (iv) generating, using a third generative machine-learned model, unique profile data based on at least one of the color palette data or the logo image data. The operations can include automatically transmitting the plurality of media assets comprising one or more image assets, text assets, and unique profile data to a content item generation pipeline for generating a plurality of candidate content items.

In some instances, generating the mask image comprising one or more bounding boxes includes identifying one or more text objects; for each text object of the one or more text objects: determining that a first text object of the one or more text objects is an overlay text object. In some instances, generating the mask image comprising one or more bounding boxes includes based on determining that the first object is an overlay text object, generating a first bounding box for the first text object.

In some instances, generating the plurality of media asset components includes extracting logo image. In some instances, generating the plurality of media asset components includes selecting a dominant color from an image color palette; upscaling the logo image by: enlarging the logo image; and sharpening the logo image. In some instances, generating the plurality of media asset components includes generatively expanding the logo image to generate one or more images, wherein each image comprises a different set of aspect ratios.

In some instances, generatively expanding the logo image includes generating pixels to blend with existing pixels of the logo image to generate a larger image than the original logo image.

In some instances, generating the plurality of background image assets includes adjusting at least one of a brightness, saturation, or contrast of the respective background image assets.

In some instances, the unique profile data comprises at least one of logo data, color palette data, font data, or image styling data.

In some instances, the operations include inputting the plurality of output assets into a content creation pipeline. In some instances, the operations include generating, by the content creation pipeline, a plurality of content items, wherein each content item of the plurality of content items comprises a unique combination of content assets and aspect ratios.

In some instances, generating the plurality of text assets includes extracting signals comprising text data. In some instances, generating the plurality of text assets includes compiling the text data. In some instances, generating the plurality of text assets includes inputting the compiled text data into the second generative machine-learned model. In some instances, generating the plurality of text assets includes obtaining at least one of short headlines or long headlines as output from the second generative machine-learned model. In some instances, generating the plurality of text assets includes inputting at least one of the short headlines or long headlines into the second generative machine-learned model. In some instances, generating the plurality of text assets includes obtaining, as output from the machine-learned model, descriptions.

In some instances, the one or more bounding boxes comprises a location and size of a bounding box.

In some instances, the content item generation pipeline comprises a prompt generation component and a content item generation component.

In some instances, the operations include generating, by the prompt generation component, an input prompt data based on the background images, the text assets, and the unique profile data. In some instances, the operations include providing the input prompt data to the content item generation component. In some instances, the operations include generating, by the content item generation component, one or more candidate content items based on the input prompt data.

In some instances, the content item generation component comprises a generative machine-learned model.

In some instances, the operations include training the generative machine-learned model by: generating a training data set based on comparing a generated content item component to an existing media asset; and based on comparing the generated content item component to the existing media asset, automatically adjusting one or more parameters of the generative machine-learned model to reduce a difference in the generated content item and the existing media asset.

In one example aspect, the present disclosure provides for an example computer-implemented method. The example computer-implemented method includes receiving data indicating a request for a plurality of media assets that comprise a plurality of media modalities to be generated based on a pre-existing media asset. The example method includes generating a plurality of media asset components by: (i) extracting one or more signals comprising at least one of background image data, color palette data, text data, or logo image data; (ii) generating, using a first generative machine-learned model, a plurality of background image assets based on at least one of the background image data, the text data, the logo image data or the color palette data; (iii) generating, using a second generative machine-learned model, a plurality of text assets based on at least one of the text data or background image data; (iv) generating, using a third generative machine-learned model, unique profile data based on at least one of color palette data, text data, or logo image data. The example computer-implemented method includes automatically transmitting the plurality of media assets comprising one or more image assets, text assets, and unique profile data to a content item generation pipeline for generating a plurality of candidate content items.

In some instances, the method includes receiving data indicative of the pre-existing media asset being uploaded.

In some instances, the method includes parsing a web resource associated with unique profile data to obtain the pre-existing media asset.

In some instances, the pre-existing media asset comprises flattened image data.

In some instances, the request is associated with a client account, and wherein the client account is associated with an account profile storing inputs to a machine-learned media asset generation pipeline.

In some instances, the profile was retrieved from a database, and wherein the profile was previously generated prior to the request.

In some instances, the present disclosure provides for an example transitory or non-transitory computer readable medium embodied in a computer-readable storage device and storing instructions that, when executed by a processor, cause the processor to perform operations. In the example transitory or non-transitory computer-readable medium, the operations include receiving data indicating a request for a plurality of media assets that comprise a plurality of media modalities to be generated based on a pre-existing media asset. The operations include generating a plurality of media asset components by: (i) extracting one or more signals comprising at least one of background image data, color palette data, text data, or logo image data; (ii) generating, using a first generative machine-learned model, a plurality of background image assets based on at least one of the background image data, the text data, the logo image data or the color palette data; (iii) generating, using a second generative machine-learned model, a plurality of text assets based on at least one of the text data or background image data; (iv) generating, using a third generative machine-learned model, unique profile data based on at least one of color palette data, text data, or logo image data. The operations include automatically transmitting the plurality of media assets comprising one or more image assets, text assets, and unique profile data to a content item generation pipeline for generating a plurality of candidate content items.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example system according to example embodiments of the present disclosure.

FIG. 2 depicts a block diagram of an example system according to example embodiments of the present disclosure.

FIG. 3 depicts a block diagram of an example system according to example embodiments of the present disclosure.

FIG. 4 depicts a flow chart diagram of an example method to generate media assets according to embodiments of the present disclosure.

FIG. 5 depicts a flow chart diagram of an example data flow for generating media assets according to embodiments of the present disclosure.

FIG. 6 depicts a block diagram of an example method to generate media assets according to embodiments of the present disclosure.

FIG. 7 depicts example graphical depictions of steps for generating media assets from an existing media asset according to embodiments of the present disclosure.

FIG. 8 depicts example graphical depictions of steps for generating media assets from an existing media asset according to embodiments of the present disclosure.

FIG. 9 depicts example graphical depictions of steps for generating media assets from an existing media asset according to embodiments of the present disclosure.

FIG. 10 depicts example graphical depictions of steps for generating media assets from an existing media asset according to embodiments of the present disclosure.

FIG. 11 depicts example graphical depictions of steps for generating media assets from an existing media asset according to embodiments of the present disclosure.

FIG. 12 depicts an example graphical depiction of an asset feedback layer according to example embodiments of the present disclosure.

FIG. 13 depicts an example graphical depiction of an asset feedback layer according to example embodiments of the present disclosure.

FIG. 14 depicts an example graphical depiction of an asset feedback layer according to example embodiments of the present disclosure.

FIG. 15 depicts example graphical depictions of steps for generating media assets from an existing media asset according to embodiments of the present disclosure.

FIG. 16 is a flow chart diagram illustrating an example method for training a machine-learned model according to example implementations of aspects of the present disclosure;

FIG. 17 is a block diagram of an example processing flow for using machine-learned model(s) to process input(s) to generate output(s) according to example implementations of aspects of the present disclosure;

FIG. 18 is a block diagram of an example sequence processing model according to example implementations of aspects of the present disclosure;

FIG. 19 is a block diagram of an example technique for populating an example input sequence for processing by a sequence processing model according to example implementations of aspects of the present disclosure;

FIG. 20 is a block diagram of an example model development platform according to example implementations of aspects of the present disclosure;

FIG. 21 is a block diagram of an example training workflow for training a machine-learned model according to example implementations of aspects of the present disclosure;

FIG. 22 is a block diagram of an inference system for operating one or more machine-learned model(s) to perform inference according to example implementations of aspects of the present disclosure;

FIG. 23 is a block diagram of an example networked computing system according to example implementations of aspects of the present disclosure;

FIG. 24 is a block diagram of an example computing device according to example implementations of aspects of the present disclosure; and

FIG. 25 is a block diagram of an example computing device according to example implementations of aspects of the present disclosure.

Reference numerals that are repeated across plural figures are intended to identify the same features in various implementations.

### DETAILED DESCRIPTION

The present disclosure generally relates to providing for generation of media asset components based on a received existing media content item For instance, the system and methods described herein can decompose an existing media content item into components. The components can be generated utilizing generative machine-learned models which can be trained and tuned based on profiles or requirements. The systems and methods can additionally, or alternatively, include recombining the media asset components such that the generated content item is visually similar (e.g., a vector difference of the two images is within a threshold amount). The present disclosure can include utilization of one or more generative machine-learned models, such as large language models capable of performing optical character recognition, generating bounding boxes for inpainting, and generating components and assets.

Existing methods do not provide for taking an initial media asset, such as a flat image and deconstructing it into various components. Existing media channels require dynamic asset components for maximum performance in different display formats. For instance, the dimension or aspect ratio required for rendering via a mobile device interface is different from that which renders on a desktop computer. Additionally, or alternatively, within a same device, different applications require a variety of aspect ratios, abbreviated descriptions, or other distinguishing features for content. As such, it is important to be able to obtain individual media asset components which can be combined on demand to satisfy these dynamic requirements. In some instances, existing media content items can be flattened images which cannot be resized without warping the image or otherwise degrading image quality. Thus, a solution is needed which can take these existing media content items and decompose them into individual media assets which can be recombined.

In some instances, the initial media content items can include flattened images where the pixels between overlaid text are inline with an underlying image. As such, the overlaid text or other media components cannot simply be removed. Additionally, some underlying background images can include text which needs to be distinguished from overlaid text (for instance an SPF indication on a sunscreen bottle compared to a graphic that says “On Sale Now”). As such, the present disclosure provides for a technical advantage over existing systems by distinguishing between overlaid text and text integrated within a background image to determine whether to initiate the spin up or utilization of other generative models in workflows. For instance, the additional models can include models capable of infilling the background image based on generated bounding boxes, generating text assets based on the overlaid text that is detected, or otherwise utilize data extracted. By determining whether the text is overlaid text or text integrated within the background image, the system can save resources by preventing the use of additional compute resources to fill in areas of a background image which should not be removed. This can prevent redundant processing and wasting of resources.

While methods exist for performing individual actions described herein, there are complications in utilizing the output from one model as input to another model to obtain high quality media asset components. For instance, adjusting the generation of masks for determining portions of an image to infill can involve iterations of training a model to distinguish between text which should be subject to inpainting and text which should not be subject to inpainting (e.g., words on a bottle within the image compared to text that was overlaid as part of an existing media asset). Additionally, ensuring that a generated media asset is similar to existing assets to comply with requirements can require tuning and training the generative model to produce media assets which satisfy image quality metrics such as clarity, or other metrics. The present disclosure allows for improved asset generation by taking in existing assets, extracting text, performing in painting, expanding base images, generating new text, and overlaying the text and expanded base images to generate new assets.

The present system and method provide for improved utilization, training, and tuning of machine-learned models to perform each step of the process to generate the new assets. By deconstructing an asset into subcomponents, the asset is no longer restricted to an initial two-dimensional, set aspect ratio. Rather, the subcomponents can be used to generate assets of various sizes, as well as expanding into additional asset types such as text only assets, image only assets, video assets, and the like.

The present disclosure can include post-processing checks which provide feedback data for the models generating the output assets to determine a quality of an image (e.g., based on distortion or blurring) and automatically adjust parameters of the system to provide for improved image quality (distortion or blurring metric that is less than the previous image generated).

In some implementations, the present disclosure relates to automatically generating content items or media assets based on a profile or preference of a client. Example implementations provide for generating, using a machine-learned media asset generation pipeline, a plurality of media assets based on a media asset profile by instructing a machine-learned asset generation model to generate media assets that align with media asset preferences of the client. Further, example implementations of the present disclosure relate generally to generating, using machine-learned models, content based on information extracted from a website. For example, a user can input a web address into the system, and the system can generate content for the user based on data extracted using the web address. Example techniques include automatically generating a plurality of content items for a communication campaign and selecting a content item from the plurality of content items based on a prediction of how well the selected content item will perform in the communication campaign.

For example, a client can be a user associated with a user account. The user can interact with a campaign generation system to create a new communication campaign. The user can interact with the campaign generation system using a user account. The campaign generation system can associate the user account with a set of campaign preferences, which can include a set of media asset preferences. If the user account is associated with other communication campaigns, the media asset preferences can include preferences obtained based on those other campaigns (e.g., preferences directly received via input from user account, preferences learned implicitly from user account actions, etc.).

The new communication campaign can communicate data directing audiences to a data resource associated with the campaign. The data can be or include a resource locator (e.g., URI, URL, deep links, app links, etc.). The data resource can be a web resource (e.g., web page, web application, etc.), a local resource (e.g., native application running on a client device), etc.

The user can provide the resource locator of the data resource to the campaign generation system. The user can provide this early in the campaign generation process, such as when initiating the generation of the new campaign. The campaign generation system can process the resource locator to identify the data resource and obtain data from and about the data resource. For instance, for a campaign pointing to a web page, the campaign generation system can use a provided URL to load the target web page, parse or crawl the page to extract pre-existing media assets (e.g., images, text, video, color palette, typography, etc.) and learn a theme, style, entity branding, etc. associated with the target web page. Other related resources can be parsed. A sitemap can be used to parse resources on a document tree on which the data resource resides. The system can parse resources that are linked on the data resource, such as based on a relevance measure of the linked resources.

The campaign generation system can predict the resource locator to prefetch content for improved latency. For instance, for a user account with known associations to a known resource locator, the campaign generation system can use the known resource locator to begin parsing the data resource even before the user confirms the resource locator.

The campaign generation system can prefetch content for improved latency by beginning to parse the data resource as soon as the resource locator is input to an input field, even if the user has not yet completed other input fields on the same interface screen. In this manner, for instance, by the time the user progresses to the next input screen, the parsing operation is well underway or already complete, thereby reducing latency for the user.

Data parsed from the data resource can be used to update the media asset preferences. The campaign generation system can use the media asset preferences to form or update an account profile that describes a communicative personality for the account (e.g., brand personality), account assets, performance data from any past campaigns, and learned features of relevant audiences and learned trends or features of a group of communicators as a whole. This account profile can be maintained dynamically as campaigns are distributed and updated, as campaign communications are received and used by the recipient endpoints, etc. The account profile can be updated dynamically as the user interacts with the machine-learned media asset generation pipeline to save a current progress, current preferences, selections, inputs, signals, etc.

The campaign generation system can collect additional input signals from the user. The input signals can refine predicted or pre-populated features of the account profile or media asset preferences. For instance, based on the data parsed from the data resource, the campaign generation system can predict initial goals for the communication campaign, general themes and styles, and other data resources relevant to the communication campaign. The user can refine, update, approve, or reject these predictions by providing additional input signals.

The additional input signals can include a product/service name, product/service description (e.g., a freeform, multiline input where the user specifies details about their product/service; can be suggested/pre populated), brand traits (e.g., adjectives that describe the brand; can be suggested for a point-and-click interface), social media opt-ins (e.g., permissions to obtain assets from social media platforms associated with the user account), etc. Machine-learned models can provide prefills for one or more of the input fields for the signals based on the account profile or the parsed data resource. A threshold can be used to prefill when a confidence level is exceeded (e.g., corresponding to a quality of prefill).

The additional input signals can be persisted in association with the user account. The additional input signals can be persisted in association with assets generated based on the additional input signals. The additional input signals can include metadata indicating whether a particular signal was manually modified by a user. This persisted signal data can be resurfaced to the user if the user, in the future, creates another related campaign. For instance, if the user creates a campaign regarding the same or similar data resource, the signal data can be resurfaced without first re-parsing the data resource. This can improve latency and decrease processing requirements. The signal data can be used as an input to the machine-learned asset generation pipeline when parsing the data resource. A subset of the signal data can be used as an input to the machine-learned asset generation pipeline, such as just the signals that have been manually confirmed/modified. In this manner, for instance, the machine-learned asset generation pipeline can learn from user inputs/corrections and avoid making the same errors with respect to future campaigns.

The campaign generation system can process data parsed from the data resource, the account profile data, and the additional input signals to obtain media assets for use in the communication campaign. The campaign generation system can implement a machine-learned media asset generation pipeline to retrieve or modify pre-existing media assets, generate new media assets, or retrieve new media assets from a database, guided by the account profile data and additional input signals. For instance, the machine-learned media asset generation pipeline can generate images (e.g., background images), headlines, descriptions, videos, logos, color palettes, sitelinks, and visual styles and themes. The machine-learned media asset generation pipeline can retrieve or modify pre-existing images, headlines, descriptions, videos, logos, color palettes, sitelinks, and visual styles and themes. The machine-learned media asset generation pipeline can query relevant databases (e.g., stock media asset databases) to obtain new images, headlines, descriptions, videos, logos, color palettes, sitelinks, and visual styles and themes.

The machine-learned media asset generation pipeline can retrieve or modify pre-existing media assets or pre-existing media content items. The machine-learned media asset generation pipeline can parse the data resource to extract any content of the data resource. The content from the data resource can be modified or optimized. For instance, images or videos can be resized, text overlays on images or videos can be removed and infilled (e.g., using machine-learned inpainting models), images or videos can be edited (e.g., exposure, coloration, sharpness, etc.). Text media assets can be rephrased, edited for clarity, etc. Logos can be identified, rescaled, optimized for overlays (e.g., removing a background, generating an alpha channel, etc.), recolored, etc. Other pre-existing assets can be obtained from a media library associated with the account. The media library can include assets used in past campaigns, assets uploaded or generated but not yet used, etc.

The machine-learned media asset generation pipeline can generate media assets using one or more machine-learned models. The machine-learned media asset generation pipeline can use a machine-learned natural language understanding model to parse text on the data resource to understand the content of the data resource and learn about the context in which the content is presented (e.g., a style or theme of the data resource). For instance, the machine-learned natural language understanding model can utilize additional data, such as image data or other context data, to determine whether the text on the data resource is overlaid text or text embedded within an image. As such, the model can determine whether further steps should be performed relating the location of content of the text. For instance, the model can determine whether to generating bounding boxes for generating a mask for the image to be infilled or inpainted. Additionally, or alternatively, the model can determine whether the detected text should be ignored or should be utilized in text generation processes (e.g., generating text assets such as headlines, descriptions, and the like). The machine-learned media asset generation pipeline can obtain a set of asset generation instructions that can be based on or include any one or more of: a representation of the content and its context, the account profile, the media asset preferences, the additional new input signals, etc.

The campaign generation system can reference an allowlist to determine if a user account is approved to use the machine-learned media asset generation pipeline. For instance, campaigns relating to products in sensitive verticals can bypass automatic asset generation and request manual control by the user. For instance, the user can be asked to provide manual inputs and controls to generate assets using machine-learned media asset generation pipeline. The user can be locked out of the machine-learned media asset generation pipeline entirely.

The machine-learned media asset generation pipeline can use a machine-learned image generation model to process the asset generation instructions to generate images that are based on and align with the asset generation instructions. Various image generation architectures can be used, including convolution neural networks, transformers, generative adversarial networks, diffusion models, etc. The image generation models can process, as example inputs, images from the data resource to prompt the models to generate similar images, text descriptions of desired images and other signals or instructions, learned soft prompts, etc. For instance, product images from the data resource can be provided to the image generation model(s) to prompt the model(s) to include the product in the generated images, to outpaint (e.g., generatively fill) around the product in a new environment, etc. This is one example of a technique to contextualize or re-contextualize product imagery while improving faithful reproduction of the product attributes. Other example techniques for image asset generation include processing assets from the data resource to extract attributes (subjects, colors, mood), using a machine-learned language model to generate a prompt based on the asset generation instructions and the extracted attributes, and inputting the prompt or the asset generation instructions and the prompt to the image generation model.

The machine-learned media asset generation pipeline can use a text generation model to process the asset generation instructions to generate text that is based on and aligns with the asset generation instructions. Various text generation architectures can be used, including convolution neural networks, transformers, generative adversarial networks, diffusion models, etc. An example architecture includes encoder-only, encoder-decoder, or decoder-only transformer-based models trained over large text corpora. The text generation models can process, as example inputs, images from the data resource to prompt relevant descriptions, textual prompts describing desired output text and other signals or instructions, learned soft prompts, etc.

In some examples, the text generation models can process the resource locator, text from the data resource, freeform text provided by the user or generated by the asset generation pipeline (e.g., using a prompt generator), existing text assets associated with the user account, tone and brand indicators (e.g., adjectives or other descriptors associated with the brand, such as may be obtained from the additional signal inputs), etc. The text generation model(s) can be configured to classify the text assets (e.g., as a call to action, promotional phrase, description, etc.). A quality of the generated asset can be evaluated (e.g., by the generation model itself, by a quality control model, etc.). This can be used for later ranking/selection of the text assets. For instance, a quality measure can include evaluating a relatedness or groundedness with respect to the data resource (e.g., evaluating whether “contactless delivery” is a phrase that accurately describes the content of the data resource). For existing text assets, the campaign generation system can process the existing text assets together with any of the above-noted inputs to rewrite the assets (e.g., change tone, etc.).

The machine-learned media asset generation pipeline can use a video generation model to process the asset generation instructions to generate videos that are based on and align with the asset generation instructions. Various video generation architectures can be used, including convolution neural networks, transformers, generative adversarial networks, diffusion models, continuous or discrete time cascaded diffusion models, etc.

The machine-learned media asset generation pipeline can use an audio generation model to process the asset generation instructions to generate audio that is based on and aligns with the asset generation instructions. Various audio generation architectures can be used, including convolution neural networks (e.g., processing spectrograms), transformers (e.g., processing sequences of audio data or embeddings thereof), generative adversarial networks, diffusion models, continuous or discrete time cascaded diffusion models, etc.

The machine-learned media asset generation pipeline can use a machine-learned prompt generator model to generate prompts for input to other generative models in the pipeline. The machine-learned prompt generator model can be trained end-to-end with one or more of the other generative models to increase performance. The prompt generator model can include a language generation model (e.g., a “large language model”). The machine-learned media asset generation pipeline can prompt the generative models with a variety of different prompts to obtain a variety of different outputs. For instance, an output layer of the prompt generation model can be sampled (e.g., randomly sampled, top-K sampled, etc.) to obtain an assortment of prompt outputs. This assortment can be input to the corresponding generative models to generate a variety of outputs related to the instructions. The prompt generator can receive a user-provided prompt and rewrite the prompt based on expressive symbolism or imagery (e.g., “progress”→“a person climbing a mountain”). For instance, the prompt can be rewritten by inputting the original prompt and an instruction to a language generation model (e.g., prompting the model, “suggest an image associated with ‘progress’”). The prompt generator model can receive a user-provided prompt (e.g., obtained in a feedback loop, as described below) or a system-rewritten prompt and expand the prompt to be more performant (e.g., “a person climbing a mountain”→“a person climbing a mountain. photography, detailed, HDR, high resolution, 4K”).

Generated assets can be associated with metadata. For example, image assets created or enhanced using the machine-learned media asset generation pipeline can have metadata stored containing information about which tools/pipelines (and which versions) were used to create or enhance the asset. This can flow to assets derived from a machine-learned media asset generation pipeline created/enhanced asset. “Enhanced” can include optimization/optimized features. In this manner, the campaign generation system can perform analysis on how well the enhancements perform (and possibly test against non-enhanced versions). Further, the campaign generation system can facilitate recall (“takedown”) of generated/enhanced assets (or derived assets) as needed. This can be limited to net-new generated content or to generated content covering major portions (20%+) of the image. For generated images where a prompt is used, the prompt can be saved. Any user-typed prompt can be saved as well as any prompt generated by a prompt generator.

The machine-learned media asset generation pipeline can query relevant databases for assets. For instance, stock photo or video databases can be queried for content similar to assets retrieved from the data resource or generated based on the data resource.

The machine-learned media asset generation pipeline can obtain assets (e.g., generate, modify, query databases) based on learned attribute insights. For instance, a learned attribute insight model can map subjects (e.g., product, topic, etc.) to additional content or keywords or features (e.g., attributes) that are associated with higher performance. For instance, an image asset for “dog toys” might be mapped to depictions of the outdoors and sunshine based on a learned relationship leading to higher performance. Such insights can be used for asset generation/modification for assets of any type. Such insights can be used to broaden or narrow search queries for related assets from an asset database. Such insights can also be surfaced to users during the generation workflow for additional information. Such insights can also be provided in prompts (e.g., passed directly to generative models, passed to prompt generators, etc.) to improve asset generation.

The machine-learned media asset generation pipeline can optimize obtained media assets. Optimization can include cropping, inpainting, outpainting, upscaling, recoloring, sharpening, or other edits or modifications. Optimization can be implemented by one or more machine-learned optimization models (e.g., image editing models, video editing models, audio editing models, etc.). Optimization can be logged in metadata. Optimization steps can be rolled back by reloading a saved state of the asset from the metadata.

The machine-learned media asset generation pipeline can rank obtained media assets. For instance, a machine-learned ranking model can rank obtained media assets based on a likelihood of performance of the media assets in the communication campaign (e.g., a predicted likelihood of a user interacting with a corresponding content item to execute a hyperlink embedded in the content item). The machine-learned ranking model can rank obtained media items based on a relevance to the data resource. The machine-learned asset generation pipeline can generate an embedded representation of the data resource and compare an embedded representation of the obtained media items to determine a relevance. The ranking can be based on a source of the image (e.g., system-generated, crawled from the data resource, user-uploaded, etc.). The ranking can be based on an image recognition result (e.g., images recognized to be of a product described on the data resource). The ranking can be based on an alignment with the additional signals input by the user.

Ranking can also be performed based on best practices. A machine-learned ranking model can be trained to identify best practices for media assets. Heuristic-based best practices can also be checked. A best practices score can be provided. The score can be based on an estimated performance lift (e.g., for a particular audience). For instance, it might be determined that positioning a product in the center of a media asset tends to see a measurable increase in website visits.

Based on the ranking, the machine-learned media asset generation pipeline can select a generated asset from the plurality of assets (e.g., new assets and/or the modified assets) in the content database to present to the user. For instance, top-ranked assets can be selected for presentation. A top-K set of assets can be selected. A sampling of assets can be selected from different rank positions (e.g., to be more robust to ranking error).

Obtained assets can be presented differently based on the ranking. For instance, to a threshold ranking, some assets can be prefilled or preselected, such that users can simply confirm the preselection to proceed. Below the threshold ranking, assets can be provided as suggestions for the user to select manually. Similarly, obtained assets can be presented differently based on the asset type. For instance, text assets may be prefilled as described above. In some situations, image assets may not be prefilled.

The campaign generation system can solicit user feedback regarding the obtained media assets. The campaign generation system can provide a user interface presenting the obtained media assets with interactive input elements provided for editing the obtained media assets. The campaign generation system can provide a user interface presenting input fields for providing natural language instructions for changes to be made to the obtained media assets (e.g., “make the flowers look brighter”) or further instructions for generating new media assets based on the candidates presented (e.g., “generate more assets like this asset”). For instance, to generate more assets like a presented asset, the campaign generation system can input, to the corresponding generative model, the existing asset as part of the prompt to generate similar assets. When generating more assets like a previously-generated asset, the prompt used to generate the previously-generated asset can be re-used. One revision option includes inputting, to the model, the existing asset (generated or otherwise) plus a prompt, then outputting multiple options of the asset as revised based on the prompt.

User feedback can be input back into the machine-learned asset generation pipeline to re-generate or re-modify the media assets according to the feedback signals. This can be performed iteratively until the user approves of the media assets.

User feedback can be obtained using a conversational input interface. For instance, a speech or text natural-language input and output interface can be provided to receive user inputs in natural language and implement the requested changes. The system can also generate outputs in natural language to describe the updates that have been performed.

The campaign generation system can output the media assets to a content item generation system. The content item generation system can generate content items using the media assets. For instance, the content item generation system can combine text assets (e.g., headlines, taglines, descriptions) with image assets (e.g., product images, background images, etc.) to create a content item for distribution. The content item generation system can generate content items based on a likelihood of utilization of the content item. For instance, utilization of the content item can include interacting with the content item to execute a hyperlink embedding in the content item. For instance, the hyperlink can direct an endpoint device to the data resource using the resource locator.

User feedback and selections can provide training data for improving one or more components of the machine-learned asset generation pipeline. For instance, a loss, reward, or penalty can be based on the user feedback and selections. The campaign generation system can train one or more components of the machine-learned asset generation pipeline to decrease the loss, increase a reward, or decrease a penalty. Training techniques can involve supervised training (e.g., with supervision provided by the user inputs), unsupervised training (e.g., learning patterns of account behavior to optimize outputs based on those patterns), reinforcement learning (e.g., the asset generation pipeline as the reward-seeking agent), etc.

Other model alignment techniques can be used, such as soft prompts. For instance, one or more soft prompts for inputs to any one or more of the generative models can be learned. A soft prompt can be associated with a particular user account or campaign. In this manner, for instance, the asset generation pipeline can be customized to improve performance for individual user accounts, optionally without retraining the entire pipeline in order to do so.

Ranking can be used earlier in the machine-learned asset generation pipeline to triage usage of available processing bandwidth. For instance, prior to generating assets, the instructions for generating the assets can be ranked (e.g., by processing the asset generation instructions and any other inputs with a machine-learned ranking model) and the media asset generation pipeline can generate the top or top K ranked instruction sets. This pre-generation ranker can be trained based on the eventual output of the machine-learned media asset generation pipeline. In this manner, for instance, fewer low-ranked media assets will be generated in the first place by ranking the instructions pre-generation. In this manner also the processing used to generate the media assets can be allocated to higher-priority (e.g., higher ranked) generation tasks.

Generated assets can be processed by a policy check. For instance, a policy check system can evaluate generated output for any sensitive material (e.g., material that is against a platform policy). The generated assets that violate the policy can be screened out and not presented to the user.

A policy check system can be applied on inputs to the campaign generation system (e.g., inputs provided by the user, data parsed from the data resource, etc.). The policy check system can screen for personally identifiable information (PII), obscenities, sensitive topics, or other policy-based screening rules. The policy check system can screen any input provided by the user or parsed from the data resource and strike it from further processing in any other model component.

According to some embodiments, the system can perform a product studio function. The product studio function can be a product for customers that enables product packaging photos. The product studio function can upscale images, remove background, and place the product in a scene (e.g., convert packaging image into a more lifestyle image). For example, the product studio function can place clothing products onto diverse models. Additionally, the product studio function can perform automatic product variants. The automatic product variants can: use aggregate data to determine what types of scenes appeal to the customer's target audience, or, alternatively, allow the customer to specify a scene; automatically identify product photos from sources (e.g. URL); remove background (if any); generate multiple variations for the product image (either placing the product in scenes or backgrounds; alternatively, if clothing, on models); and/or the scenes can all be tested on traffic to see which performs the best. For example, for a lotion campaign, the system can place the product with a palm tree, in the woods, etc. if the system determines that this product placement will lead to more user clicks or conversions. The product studio function can also upscaling images.

The product studio function can generate scenes by using a ML model to accept an image and text input. Moreover, the system can generate some text input using a formula for optimum results: “<product type> <platform> surrounded by <surroundings> in front of <background>” or for example “Skincare jar on a light stone platform surrounded by almonds and in front of green plants.” The system can generate this text automatically. Additionally, the original product image can be re-layered back over ML outputs to ensure the integrity of the product. In some instances, the ML model can sometimes modify more than the background. The system can apply edge smoothing to ensure the product blends with the scene. The system can move the product lower-than-center so the ML model can place the product on a surface better.

Examples of the disclosure provide several technical effects, benefits, and/or improvements in computing technology and artificial intelligence techniques that involve the use of machine learning algorithms to generate new data, such as images, audio, text, video, or other types of media. The techniques described herein improve the use of generative models by improving the quality of the generated content. The quality of the generated content is tailored specifically to the entity (e.g., company, user) by using data extracted from a web resource of the entity. For example, by using more content-relevant data, the system improves the performance of generative models. Additionally, the system utilizes better training techniques by developing more efficient and effective training techniques that are specific to the entity (e.g., based on data extracted from a web resource of the entity) to reduce the time and resources required to train models. Moreover, the system can incorporate user feedback and provide the feedback, via reinforcement learning or active learning, to generative models that can help the models learn from user preferences and improve over time. Furthermore, the present disclosure can reduce processing by reducing the number of manual inputs provided by a user and by reducing the number of interface screens which must be obtained, loaded, interacted with, and updated. For example, the user may only have to input a web address of a website, and the system can automatically extract content from the website and automatically generate content items for the user.

With reference now to the Figures, example embodiments of the present disclosure will be discussed in further detail.

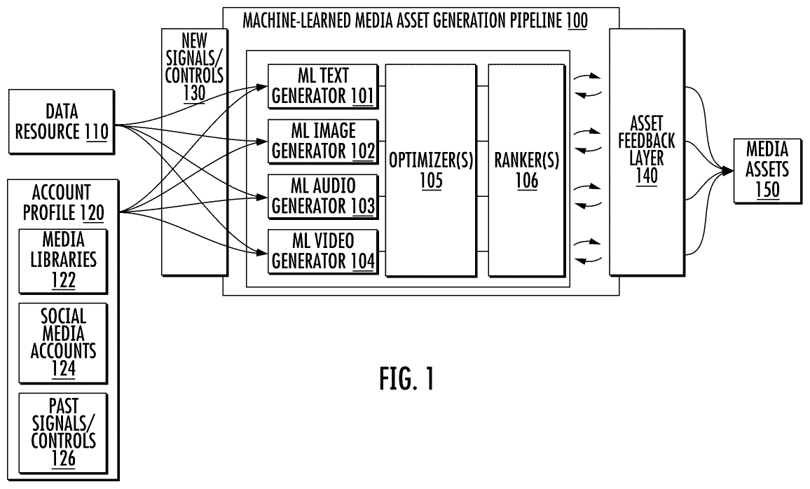

FIG. 1 depicts an example system for implementing a machine-learned media asset generation pipeline 100. Machine-learned media asset generation pipeline 100 can include a machine-learned text generator 101. Machine-learned media asset generation pipeline 100 can include a machine-learned image generator 102. Machine-learned media asset generation pipeline 100 can include a machine-learned audio generator 103. Machine-learned media asset generation pipeline 100 can include a machine-learned video generator 104. Machine-learned media asset generation pipeline 100 can include one or more optimizer(s) 105 to apply one or more optimization algorithms to the outputs of any one or more of machine-learned generator models 101 to 104. Machine-learned media asset generation pipeline 100 can include one or more ranker(s) 106 to rank outputs of any one or more of machine-learned generator models 101 to 104.

Machine-learned media asset generation pipeline 100 can ingest data from a data resource 110 and data from an account profile 120. Account profile 120 can include media asset preferences. Account profile 120 can include media libraries 122. Account profile 120 can include social media accounts 124. Account profile 120 can include past signals/controls 126 input to the machine-learned media asset generation pipeline 100. Machine-learned media asset generation pipeline 100 can process the data retrieved from data resource 110 and account profile 120 according to new signals/controls 130. New signals/controls 130 can include user inputs customizing the media asset generation.

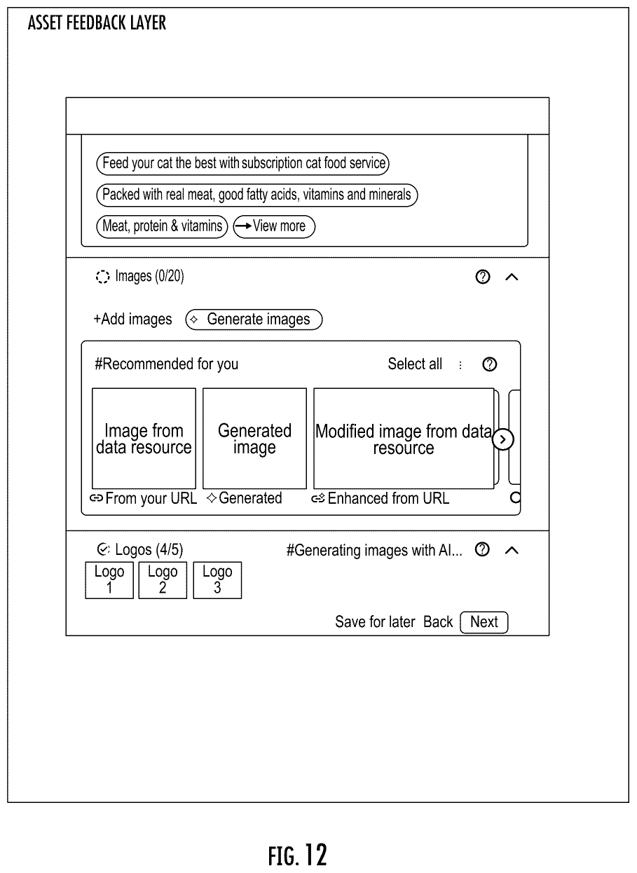

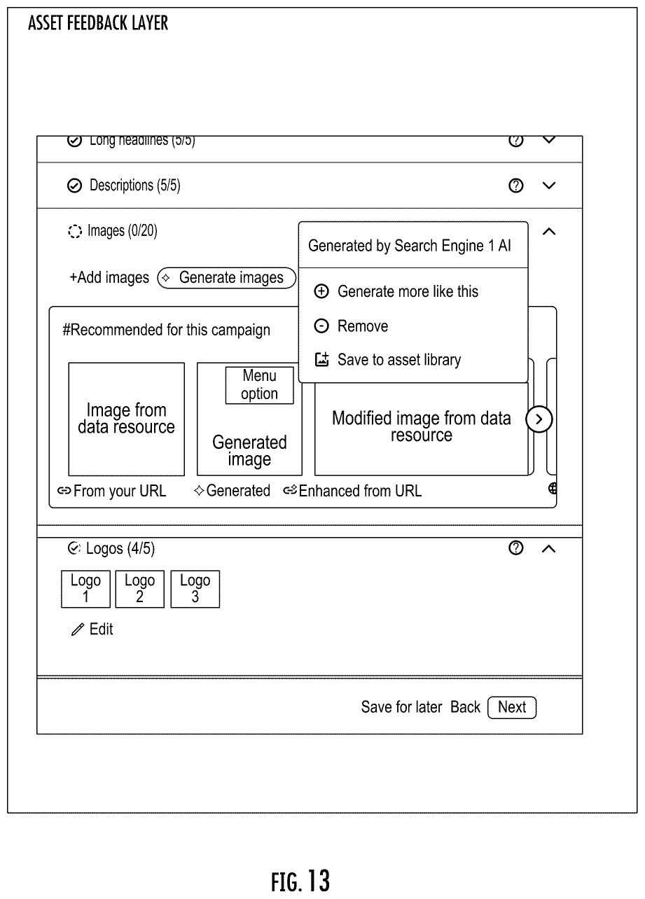

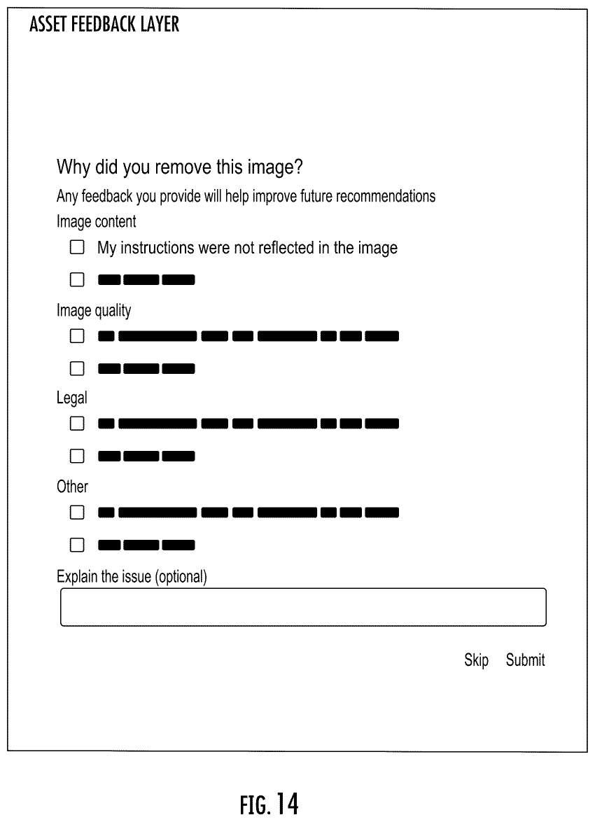

Machine-learned media asset generation pipeline 100 can include an asset feedback layer 140. Asset feedback layer 140 can facilitate input of user feedback on generated assets and initiate generation of updated or different assets. After selection, confirmation, or approval using asset feedback layer 140 (e.g., as depicted in FIG. 12, FIG. 13, and FIG. 14), machine-learned media asset generation pipeline 100 can output media assets 150. Media assets 150 can include any type of media asset output. Media asset output can include, for example text assets, image assets, audio assets, video assets, and/or unique profile data (e.g., brand profile data, color palette, logo).

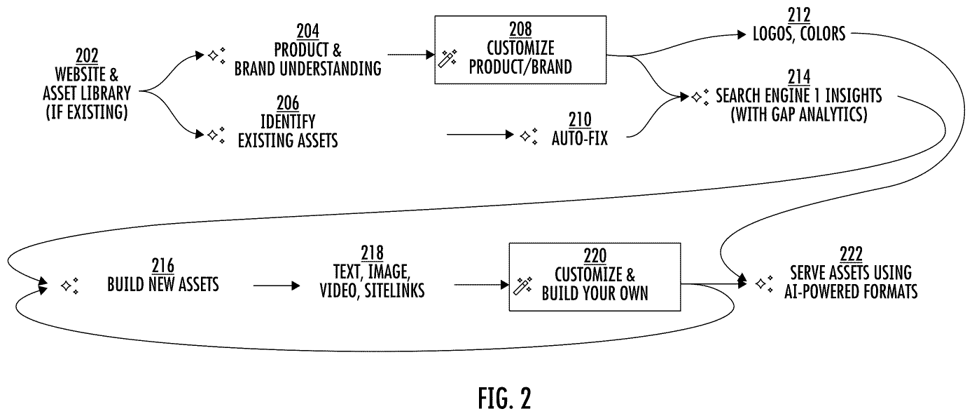

FIG. 2 depicts a flow diagram of an example machine-learned media asset generation pipeline 200 according to example embodiments of the present disclosure. In some instances, the system can receive a website and/or asset library at 202. At 204, the system can determine a product and brand understanding based on the information received and/or obtained at 202. At 206, the system can identify existing assets based on the information received and/or obtained at 202. At 208, the system can customize a product and/or brand based on the determination at 204. At 210, the system can modify (e.g., update) the existing assets that are identified at 206. At 212, the system can determine logos and colors based on the information derived at 208 and/or 210. At 214, the system can determine insights about the company and/or products based on the information derived at 208 and/or 210. At 214, the system can also perform a gap analysis to predict, or auto-generation missing information based on the information derived at 208 and/or 210.

Additionally, at 216, the system can generate new assets based on the information derived at 214. At 218, the system can modify the new asset generated at 216 by adding (e.g., modifying) text, image, videos, and/or sitelinks. The text, image, videos, and/or sitelinks that are selected at 218 can be determined or generated based on information derived at 212 and 214. At 220, the system can receive user input to customize the new assets that are generated at 216 and modified at 218. At 222, the system can serve (e.g., present) the customized assets 220 using AI-powered formats.

The machine-learned media asset generation pipeline 200 can include an overall model. The overall model can be a machine-learned generation model that is configured to generate a plurality of content items. Additionally, or alternatively, the overall model can be a machine-learned selection model that is configured to select a selected content item from the plurality of content items In some implementations, the overall model is trained to receive a set of input data 204 descriptive of a web resource and, as a result of receipt of the input data 204, provide output data 206 that automatically generated new media assets and content items. For example, the system can receive, from a user device of a user, user input associated with a web resource. The system can extract a plurality of assets (e.g., an image, a word, a video, or an audio file) from the web resource. Additionally, the system, using the overall model (e.g., machine-learned generation model), can process the plurality of assets to generate the plurality of content items. Moreover, the system, using the overall model (e.g., a machine-learned selection model), can determine the selected content item from the plurality of content items. Subsequently, the system can cause the presentation of the selected content item on a graphical user interface displayed on the user device.

In another embodiment, the system can receive data indicating a request for a plurality of media assets that comprise multiple media modalities. Additionally, the system can obtain a media asset profile for a client account associated with the request. The media asset profile can include data indicating media asset preferences for the client account, and the media asset profile can be generated by processing pre-existing media assets associated with the client account. The system can generate, using a machine-learned media asset generation pipeline 200, the plurality of media assets based on the media asset profile by instructing an overall model (e.g., machine-learned asset generation model) to generate media assets that align with the media asset preferences. Subsequently, the system can send, based on receiving data indicating selection of one or more of the plurality of media assets, the one or more of the plurality of media assets to a content item generation system for generating content items using the one or more of the plurality of media assets.

According to some embodiments, the system can work alongside a client to curate and create quality, engaging media assets of all kinds for the client's business automatically. Any business, large or small, can start advertising with the system in seconds, even without any assets yet. The system can lower the barrier for all businesses to reach their customers in a personalized and engaging way and democratize advertising creative development for everyone.

The system can combine the best machine learning models, including generative AI, and deep insights to help fill out an entire asset group for most new campaigns automatically in real time. With one click, a client can immediately start with an asset group set to deliver results for client-specific goals, then be able to modify the content items and/or media assets based on suggestions received from the system.

For example, the client can input as much or as little information to generate content items, and as the client generates these content items, the client can in some implementations be able to see the system's assumptions, have the opportunity to make refinements, and accept the media assets (e.g., content items) that the client wants. The client can publish the recommended media assets directly, or just use them as a starting point to customize or build their own.

The system can include a user interface framework for collecting inputs for intelligent asset creation, collection, and combination. The system can surface these assets and the system's assumptions back to clients (e.g., customers). The system can enable refinements of the media assets based on user input, all within the media asset construction process or onboarding flow process.

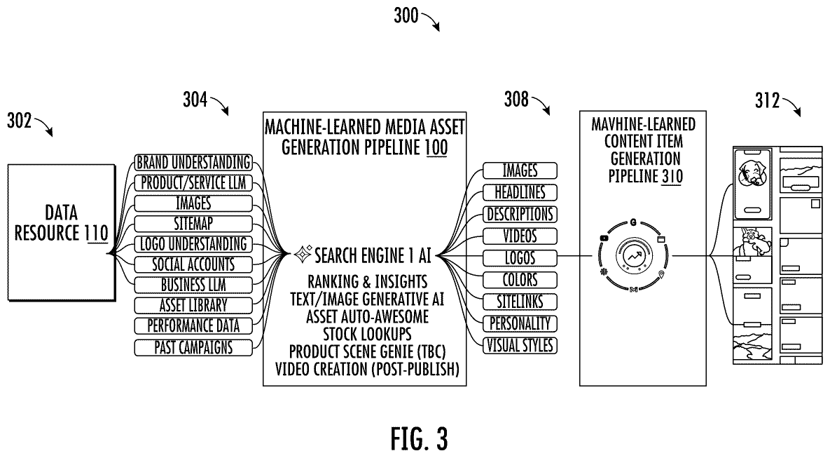

FIG. 3 depicts a block diagram 300 of an example system according to example embodiments of the present disclosure. The system can receive a URL 302 from a user. For example, the system can receive, from a user device of a user, user input associated with the URL. The system can extract a plurality of assets 304 from a data resource 110 associated with the URL 302. The plurality of assets 304 can include brand understanding, product, and service large language model (LLM), images, sitemap, logo understanding, social accounts, business LLM, asset library, performance data, past campaign data. Additionally, the system, machine-learned media asset generation pipeline 100 can process the plurality of assets 304 to generate the plurality of content items 308. The overall model 306 can perform ranking and insights determination, text and/or image generative artificial intelligence, asset auto-generate, stock lockups, product generation, and video creation. The plurality of content 308 can include images, headlines, descriptions, videos, logos, colors, sitelinks, personality, and visual styles. The system can use a machine-learned content item generation pipeline 310 to determine the selected media assets from the plurality of media assets to generate content items 312. Subsequently, the system can cause the presentation of a new content item on a graphical user interface displayed on a user device.

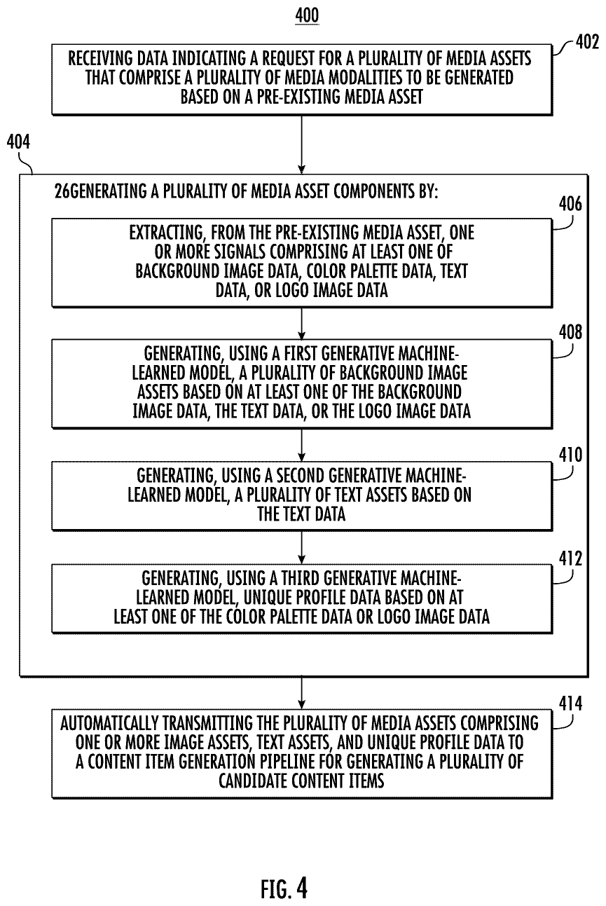

FIG. 4 depicts a flow diagram of an example method 400 to media asset generation by deconstructing existing content items in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, method 400 is performed by a server computing system (e.g., server computing system 60) or client computing system (e.g., computing devices 50). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processors can be omitted in various embodiments. Thus, not all processes are required in every embodiment. Other process flows are possible.

At operation 402, processing logic can receive data indicating a request for a plurality of media assets that include a plurality of media modalities to be generated based on a pre-existing media asset. For instance, in some implementations, processing logic can receive data indicative of the pre-existing media asset being uploaded. For instance, a user can provide a pre-existing media asset to the system via an online portal or other interface. In some implementations, the pre-existing media asset can be obtained by parsing a web resource associated with unique profile data to obtain the pre-existing media asset. For instance, a user can have an account associated with unique profile data. A URL can be provided for a web resource which can be parsed for pre-existing media assets.

The pre-existing asset can include flattened image data. For instance, the pre-existing asset can be a jpg or other image file comprising a single layer of pixels. This is distinguishable from a multi-layered image file which can include various layers which can have overlapping or differing pixel values based on the layer. A layered image file can be more easily broken into components whereas in a flattened image the multiple layers (such as a background image and overlaid text) are combined or merged into a single layer. Thus, the pixels of the top layer overwrite the pixels of the lower layers such that portions of the original background image are unrecoverable.

In some implementations, the request is associated with a client account, and wherein the client account is associated with an account profile storing inputs to a machine-learned media asset generation pipeline. The profile can be retrieved from a database, and the profile can be previously generated prior to the request. For instance, a user identifier can be associated with a profile or unique profile data.

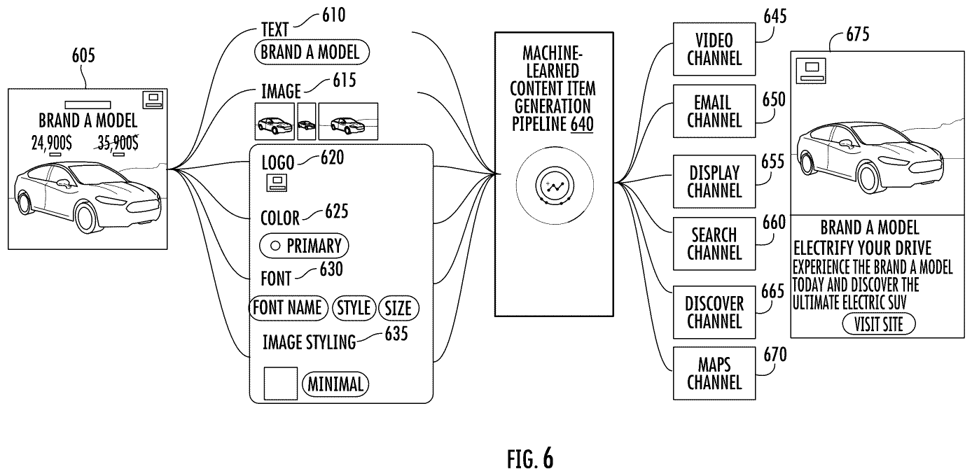

At operation 404, processing logic can generate a plurality of media components by performing operation 406, operation 408, operation 410, and operation 412. For instance, turning to FIG. 6, the processing logic can obtain a pre-existing media asset 605. The operations performed can generate a plurality of media assets. The media assets can include text assets, image assets 615, and unique profile assets such as logo assets 620, color assets 625, font assets 630, image styling 635.

The media assets can be obtained by machine-learning content item generation pipeline 640 to generate assets for various media channels as will be discussed further with regard to operation 414.

Generating a plurality of media asset components can include extracting a logo image. Generating a plurality of media asset components can include selecting a dominant color from an image color palette. Generating a plurality of media asset components can include upscaling the logo image by enlarging the logo image and/or sharpening the logo image.

Generating a plurality of media asset components can include generatively expanding the logo image to generate one or more images. Each image can include a different set of aspect ratios. Generatively expanding the logo image can include generating pixels to blend with existing pixels of the logo image to generate a larger image than the original logo image.

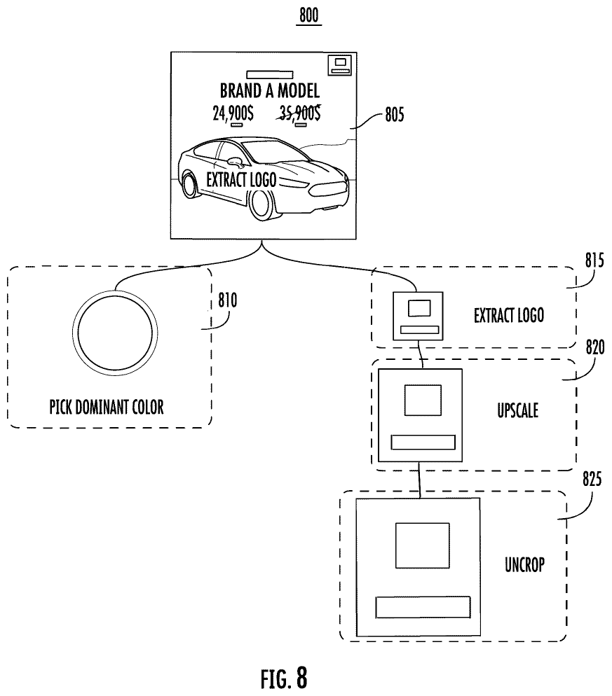

For instance, turning to FIG. 8, a graphical depiction 800 of extracting and generating unique profile (e.g., brand profile) data such as a dominant color and logos are depicted. For instance, a pre-existing asset 805 can be utilized as input into a machine-learned asset generation pipeline. The pipeline can extract or otherwise determine a dominant color 810. Additionally, or alternatively the pipeline can extract a logo 815 from the image. The logo 815 which is extracted may be low resolution or otherwise not suitable for use in generating future assets. As such, the pipeline can upscale 820 a logo to create a larger version while maintaining crisp visual resolution. Additionally, or alternatively, the pipeline can uncrop 825 the logo or otherwise generatively outpaint the logo to create a larger visual buffer around the logo.

At operation 406, processing logic can extract from the pre-existing media asset, one or more signals comprising at least one of background image data, color palette data, text data, or logo image data.

At operation 408, processing logic can generate, using a first generative machine-learned model, a plurality of background image assets. In some instances, generating the plurality of background images can include generating, based on at least one of the background image data, the text data, or the logo image data, a mask image comprising one or more bounding boxes. The one or more bounding boxes can include a location and size of a bounding box.

In some instances, generating the plurality of background images can include inpainting the mask image by generating, using a machine-learned model, pixels to fill the one or more bounding boxes of the mask image. In some instances, generating the plurality of background images can include generating a plurality of images, wherein each image comprises distinct aspect ratios.

Generating the plurality of background image assets can include adjusting at least one of a brightness, saturation, or contrast of the respective background image assets.

Generating, based on at least one of the background image data, the text data, or the logo image data, a mask image comprising one or more bounding boxes can include identifying one or more text objects. For each text object of the one or more text objects, generating the mask image can include determining that a first text object of the one or more text objects is an overlay text object. For each text object of the one or more text objects, generating the mask image can include, based on determining that the first object is an overlay text object, generating a first bounding box for the first text object.

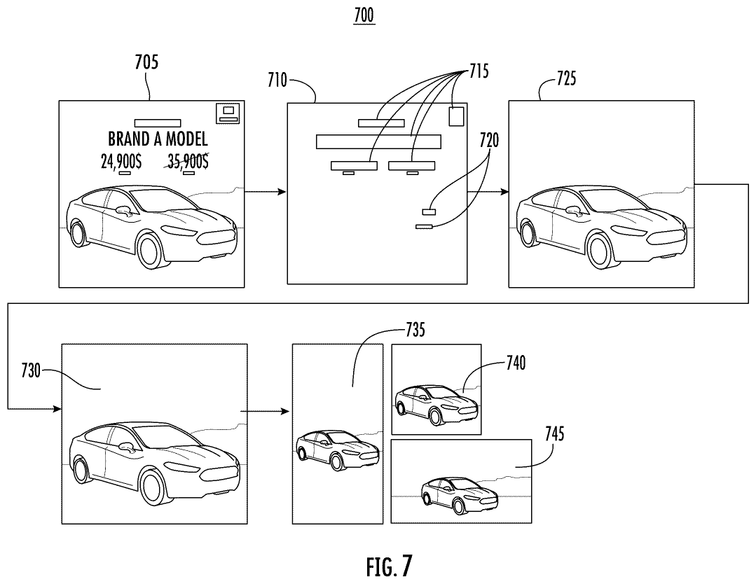

FIG. 7 depicts an example graphical depiction 700 of generating a number of background image media assets based on a pre-existing media asset 705 (e.g., existing content item). For instance, Pre-existing media asset 705 can be input into a model which can generate a number of bounding boxes (e.g., bounding boxes 715 and bounding boxes 720) to create a mask 710. The system can determine which bounding boxes should be infilled by determining which are associated with overlaid text like bounding boxes 715 and those associated with underlying image text such as bounding boxes 720.

For instance, the model can be trained to differentiate between the bounding boxes which should be inpainted and which should be disregarded and not included in the mask. Output image 725 can be an image generated by inpainting bounding boxes 715.

In some implementations, the background image generation model can enhance the image by adjusting the saturation, sharpness, brightness, or other features of the image to generate enhanced image 730.

In some implementations, the background image generation model can outpaint or otherwise generatively expand the image to provide for background images with varying aspect ratios. For instance, background image 735 can be more suitable for a full screen mobile application advertisement, background image 740 can be more suitable for a search or email advertisements, and background image 745 can be more suitable for a desktop-rendered advertisement.

At operation 410, processing logic can generate, using a second generative machine-learned model, a plurality of text assets. Generating the plurality of text assets can include obtaining the text data associated with the one or more bounding boxes. Generating the plurality of text assets can include inputting the text data into a machine-learned model. Generating the plurality of text assets can include generating, by the machine-learned model a plurality of text assets as output.

Generating the plurality of text assets can include extracting signals comprising text data. Generating the plurality of text assets can include compiling the text data. Generating the plurality of text assets can include inputting the compiled text data into the second generative machine-learned model. Generating the plurality of text assets can include obtaining at least one of short headlines or long headlines as output from the second generative machine-learned model. Generating the plurality of text assets can include inputting at least one of the short headlines or long headlines into the second generative machine-learned model. Generating the plurality of text assets can include obtaining, as output from the machine-learned model, descriptions.

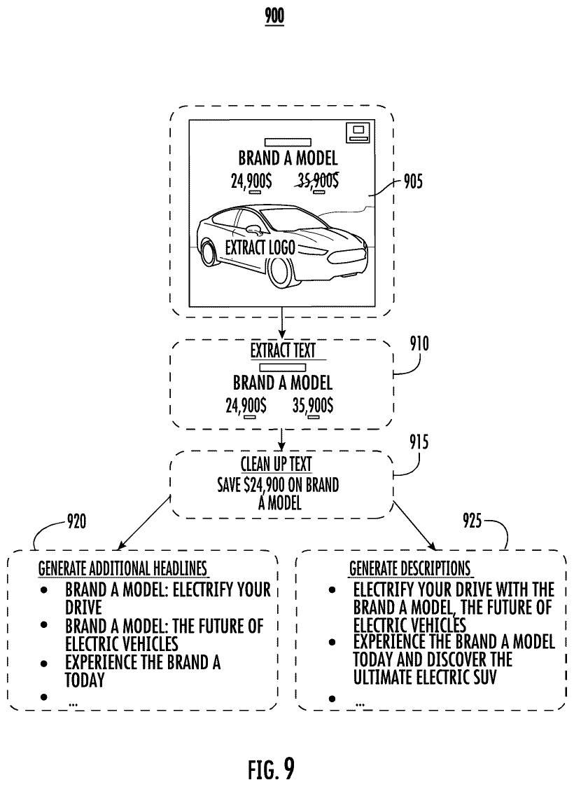

Turning to FIG. 9, one can see an example graphical depictions 900 of extracting and generating text data including headlines and descriptions from a pre-existing media content item 905. The processing logic can extract the text from the pre-existing media content item 905 to generate text data signals 910. The text data signals 910 can be cleaned up to generate cleaned up text 915. Cleaned up text 915 can be utilized as input in the second generative machine-learned model to generate additional headlines 920 and/or descriptions 925. The headlines 920 and/or descriptions 925 can be utilized by content item generation pipeline to generate one or more media content items for various media channels.

At operation 412, processing logic can generate, using a third generative machine-learned model, unique profile data based on at least one of the color palette data or the logo image data. The unique profile data can include at least one of logo data, color palette data, font data, or image styling data. Unique profile data can include brand data associated with a profile or other identifier. For instance, unique profile data can be associated with the “look and feel” of typical content items associated with a profile (e.g., business).

At operation 414, processing logic can automatically transmit the plurality of media assets comprising one or more image assets, text assets, and unique profile data to a content item generation pipeline for generating a plurality of candidate content items. The content item generation pipeline comprises a prompt generation component and a content item generation component.

In some instances, processing logic can generate, by the prompt generation component, an input prompt data based on the background images, the text assets, and the unique profile data. Processing logic can provide the input prompt data to the content item generation component. Processing logic can generate, by the content item generation component, one or more candidate content items based on the input prompt data. The content item generation component comprises a generative machine-learned model.

In some implementations, processing logic can train the generative machine-learned model. For instance, training the generative machine-learned model can include generating a training data set based on comparing a generated content item component to an existing media asset. Training the generative machine-learned model can include, based on comparing the generated content item component to the existing media asset, automatically adjusting one or more parameters of the generative machine-learned model to reduce a difference in the generated content item and the existing media asset.

In some implementations, processing logic can input the plurality of output assets into a content creation pipeline. The processing logic can generate, by the content creation pipeline, a plurality of content items, wherein each content item of the plurality of content items comprises a unique combination of content assets and aspect ratios.

Turning back to FIG. 6, the machine-learned content item generation pipeline 640 can generate content items to be displayed via a variety of media channels which require different formats. For instance, media channels can include video channel 645, email channel 650, display channel 655, search channel 660, discover channel 665, and/or maps channel 670. Different channels can require different formats, for instance, some can include image, text, and audio whereas others may only include text. An example discover channel asset 675 is depicted which shows a combination of image, text, logo, and embedded (e.g., selectable component that links to a URL) assets.

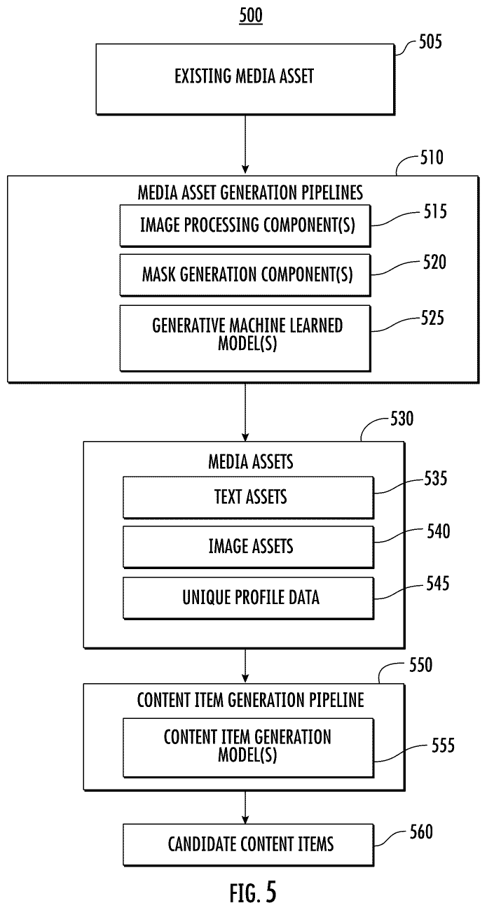

FIG. 5 depicts a flow chart diagram of an example data flow 500 for generating media assets according to embodiments of the present disclosure. For instance media asset generation pipeline(s) 510 can obtain an existing media asset 505 (e.g., a pre-existing content item) as input. Media asset generation pipeline(s) 510 can include image processing component(s) 515, mask generation component(s) 520, and/or generative machine-learned model(s) 525. Image processing component(s) 515 can process the existing media asset 505 to extract background image data, text data, color palette data, or other relevant data. The mask generation component(s) 520 can determine which portions of the background image should be generatively infilled (e.g., to remove overlaid text). Generative machine-learned model(s) 525 can generatively fill based on the masks generated as well as generate text or other assets based on any of the extracted signals associated with the existing media asset 505.

Media asset generation pipeline(s) 510 can output media assets 530. Media assets 530 can include text assets 535, image assets 540, and/or unique profile data 545. As described herein, text assets 535 can include words, sentences, paragraphs, or other phrases. Image assets 540 can include background images, logo images, or other images. Unique profile data 545 can include brand information or other information associated with a user profile.

The media assets 530 can be ingested by content item generation pipeline 550 to generate candidate content items 560. Content item generation pipeline 550 can include content item generation model(s) 555 which can utilize media assets 530 and/or other signals as input in order to generate candidate content items 560. The generated candidate content items 560 can be content items that are generated in a new way such that they appear visually different from the original pre-existing media asset.

The system described herein can perform a number of methods. For instance, example methods can be implemented by one or more computing systems (e.g., one or more computing systems as discussed with respect to FIGS. 1 to 25). The various steps of the methods can be omitted, rearranged, combined, and/or adapted in various ways without deviating from the scope of the present disclosure.

A computing system can receive, from a user device of a user, user input associated with a web resource, the web resource being associated with an account of the user.

A computing system can extract a plurality of assets from the web resource, wherein each asset in the plurality of assets is an image, a word, a video, or an audio file.

A computing system can process, using the machine-learned generation model, the plurality of assets to generate the plurality of content items.

A computing system can determine, using the machine-learned selection model, the selected content item from the plurality of content items.

A computing system can cause the presentation of the selected content item on a graphical user interface displayed on the user device.

In some instances, the operations can further include receiving a user interaction on the graphical user interface, the user interaction modifying the selected content item. Additionally, the operations can include processing, using the machine-learned generation model, the user interaction, and the selected content item to generate a modified content item. Moreover, the operations can include causing the presentation of the modified content item on the graphical user interface displayed on the user device. Furthermore, one or more parameters of the machine-learned generation model can be updated based on the user interaction.

In some instances, the operations can further include receiving a user interaction on the graphical user interface. The user interaction can be associated with rejecting the selected content item. Additionally, the operations can include processing, using the machine-learned selection model, the plurality of content items and the user interaction to generate a new content item. Moreover, the operations can include causing the presentation of the new content item on the graphical user interface displayed on the user device.

In some instances, the operations can further include receiving a user interaction on the graphical user interface, the user interaction accepting the selected content item. Additionally, the operations can include determining, using a machine-learned model, an advertisement campaign based on the selected content item. Moreover, the operations can include causing the presentation of the advertisement campaign on the graphical user interface displayed on the user device.

In some instances, the web resource can be a website, and the user input is a Uniform Resource Locator (URL) of the website.

In some instances, the plurality of content items can include a first content item, and the first content item can be generated by modifying an image asset of the plurality of assets. Additionally, the plurality of content items can include a second content item, and the second content item is a generative image generated by the machine-learned generation model using the image asset.

In some instances, the operations can further include calculating, using the machine-learned selection model, a conversion score for each content item in the plurality of content items, the conversion score indicating the likelihood that a user interacts with the respective content item. For example, the selected content item can be the content item with the highest conversion score in the plurality of content items.

In some implementations, a computing system can receive data indicating a request for a plurality of media assets that comprise multiple media modalities.

A computing system can obtain a media asset profile for a client account associated with the request, wherein the media asset profile comprises data indicating media asset preferences for the client account, and wherein the media asset profile was generated by processing pre-existing media assets associated with the client account.

A computing system can generate, using a machine-learned media asset generation pipeline, the plurality of media assets based on the media asset profile by instructing a machine-learned asset generation model to generate media assets that align with the media asset preferences.

A computing system can send, based on receiving data indicating selection of one or more of the plurality of media assets, the one or more of the plurality of media assets to a content item generation system for generating content items using the one or more of the plurality of media assets.

In some instances, the multiple media modalities include two or more modalities selected from: text, image, or audio.

In some instances, the operations can further include generating data for the media asset profile by parsing a web resource associated with the client account.

In some instances, the operations can further include parsing the web resource to extract the pre-existing media assets from the web resource.

In some instances, the operations can further include parsing the web resource to extract visual style data associated with the client account. For example, the visual style can include color information, layout information, or typography information.

In some instances, the operations can further include parsing the web resource to extract textual style data associated with the client account. The textual style data can include an intonation or inflection of copy on the web resource.

In some instances, the operations can further include parsing the web resource to extract landing page data associated with the client account. The landing page data can include URLs to web pages associated with the plurality of media assets.

In some instances, the media asset profile was retrieved from a database, and the media asset profile was previously generated prior to the request.

In some instances, the operations can further include generating at least one of the plurality of media assets by editing a pre-existing image asset using at least one of the following editing operations: crop, rotate, infill, recolor, defocus, deblur, denoise, relight. The editing operations are optionally implemented with machine-learned image editing tools. Additionally the pre-existing image asset can be edited based on historical performance data associated with image assets. Moreover, the pre-existing image asset can be edited based on a set of content item guidelines for generating content items using the pre-existing image asset.

In some instances, the operations can further include inputting, to a machine-learned media asset generation model, data from the media asset profile and a request for generated assets consistent with the data from the media asset profile.

In some instances, the operations can further include determining, using a machine-learned performance estimation model, one or more generated assets, wherein the machine-learned performance estimation model is configured to identify asset characteristics associated with historical performance data. Additionally, the operations can further include generating, using the machine-learned performance estimation model, an augmented input for input to the machine-learned media asset generation model to induce asset characteristics associated with historical performance data. Moreover, the operations can include ranking, using the machine-learned performance estimation model, the generated assets from the machine-learned media asset generation model.

In some instances, the operations can further include presenting, on a user interface accessible by the client account, one or more generated media assets for review. Additionally, the operations can include receiving, via the user interface, inputs providing corrections to the one or more generated media assets. Moreover, the operations can include re-generating, using the machine-learned media asset generation pipeline, the one or more generated media assets based on the received inputs. Furthermore, the user interface can include one or more selectable input elements associated with the one or more generated media assets and indicating a corresponding corrective action to be performed with respect to the one or more generated media assets. The selectable input elements can be configured to provide, upon selection, the received inputs. The user interface can include a natural language input element for receiving corrective inputs in natural language format, where the natural language input element is configured to provide the received inputs.

In some instances, the media asset profile can be based on at one or more features of the following features, the one or more features being associated with the client account: a machine-learned model, images, sitemap, logo, social media accounts, asset library, performance data, past sets of media assets, past sets of generated media assets.

In some instances the plurality of media assets can include two or more categories of the following categories: images, headlines, descriptions, videos, logos, colors, sitelinks, calls to action, audio.

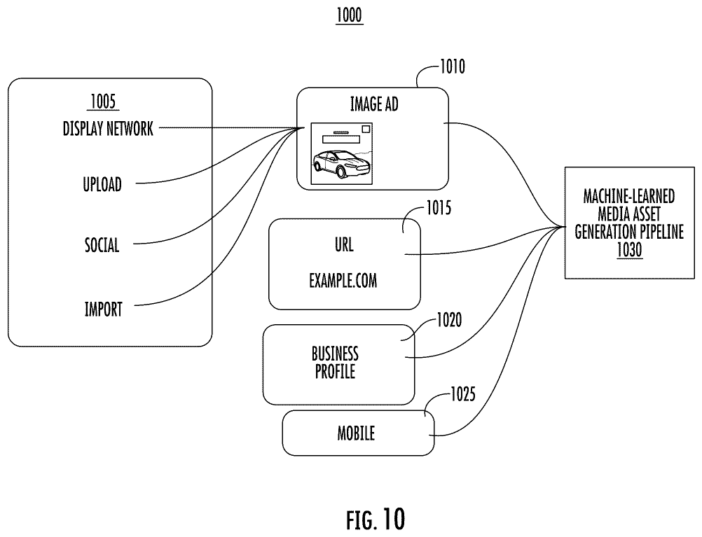

FIG. 10 depicts an example graphical depiction of extracting existing media assets from sources 1005 associated with an account and utilizing media assets generated from the extracted asset and other sources as input into a machine-learned media asset generation pipeline 1030. For instance, sources 1005 can include display network channel, an upload, social media, or importation. The sources 1005 can be accessed to obtain image advertisement 1010. Image advertisement 1010 can be a pre-existing content item such as a flattened image advertisement.

Machine-learned media asset generation pipeline 1030 can utilize various inputs to generate a plurality of media assets. The various inputs can include image ad 1010, URL 1015, business profile 1020, and/or mobile input 1025. The inputs can be utilized to generate the background image assets, text assets, and/or unique profile data as described herein.

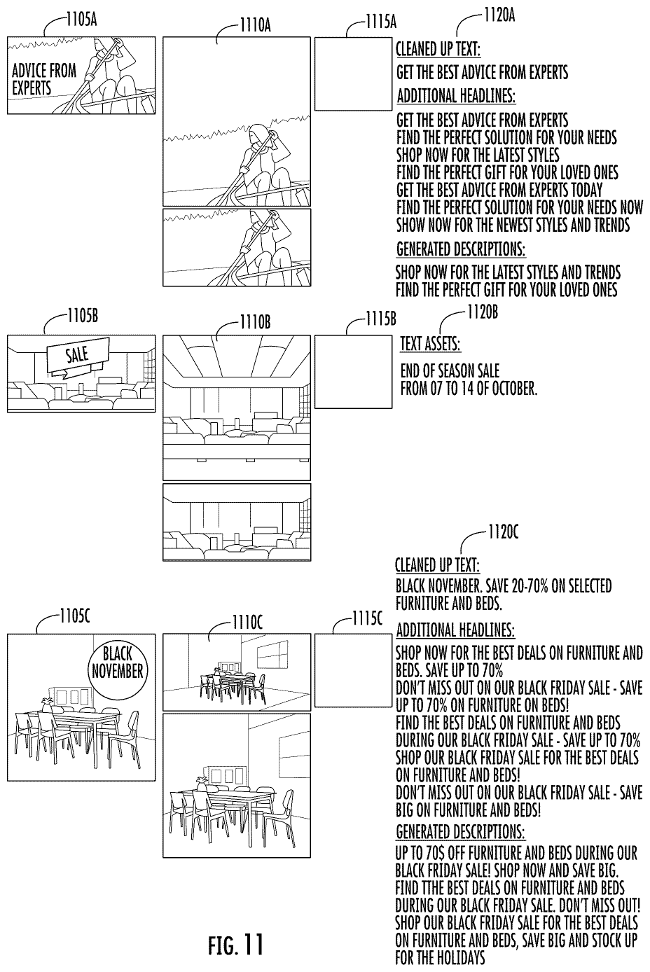

FIG. 11 depicts examples of extracting media assets from pre-existing content items. For instance, the content items can include content item 1105A, content item 1105B, content item 1105C. The system can generate a plurality of candidate background images such as background image 1110A, background image 1110B, and background image 1110C. The system can determine a primary color and/or color palette such as color 1115A, color 1115B, or color 1115C. The system can generate text assets such as text asset 1120A, text asset 1120B, and text asset 1120C. The background images 1110A, 1110B, and/or 1110C can be generated utilizing the methods described herein including mask generation, infilling/inpainting, and generatively expanding (e.g., uncropping).

FIG. 12 illustrates an example user interface for interacting with asset feedback layer 140. Asset feedback layer 140 can display obtained media assets along with a source indicator (e.g., “From your URL,” etc.). In some implementations, Asset feedback layer 140 can display loading indicators while receiving generated assets from machine-learned media asset generation pipeline 100 (e.g., solid bars in place of not-yet-loaded text). Asset feedback layer 140 can pre-populate a field of assets with generated assets.

Asset feedback layer 140 can display loading indicators while receiving generated assets from machine-learned media asset generation pipeline 100 (e.g., solid areas in place of not-yet-generated images). In some instances, illustrate different loading status messages (e.g., “#Generating images with AI,” “#Looking for best-matching stock images”).

FIG. 13 illustrates an example user interface for interacting with asset feedback layer 140. Asset feedback layer 140 can provide a menu option in association with obtained assets for performing actions in association with the asset.

FIG. 14 illustrates an example user interface for interacting with asset feedback layer 140. Asset feedback layer 140 can provide a menu option for removing an asset. Asset feedback layer 140 can provide an interface for providing feedback associated with removal of the asset. The feedback can be used to train one or more components of machine-learned media asset generation pipeline 100.

Additionally, or alternatively, asset feedback layer 140 can provide an interface for generating additional assets. Asset feedback layer 140 can provide suggested asset generation prompts, which can be configured to be selectable for initiating processing of the suggested prompt. Asset feedback layer 140 can provide example generated assets. Asset feedback layer 140 can provide an interface for browsing outputs associated with a given prompt. Asset feedback layer 140 can provide an interface for inputting a natural language prompt.

Additionally, or alternatively, asset feedback layer 140 can provide an interface for viewing other extracted and suggested media assets, such as colors, text assets, sitelinks, etc.

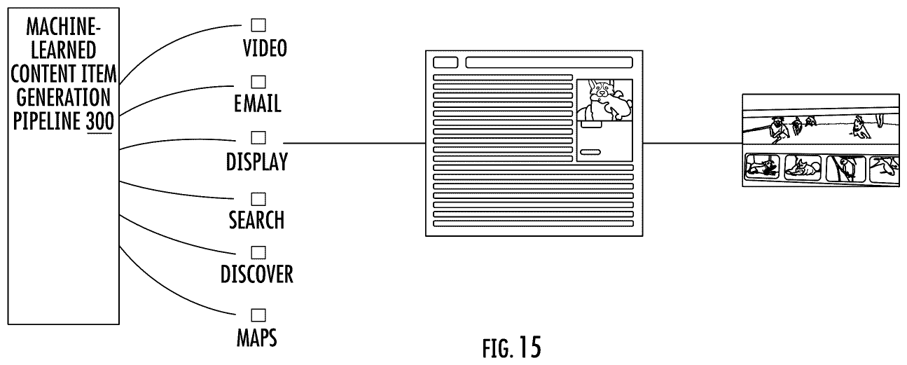

FIG. 15 illustrates an example data flow for generating a variety of content items for a variety of distribution mechanisms (e.g., media channels). The content items can be configured to cause, responsive to an interaction, loading of a data resource (e.g., data resource 110 as depicted in FIG. 1). For instance, machine-learned content item generation pipeline 310 can generate content items for a plurality of media channels such as video, email, display, search, discover or maps. Two example formats are depicted in FIG. 15.

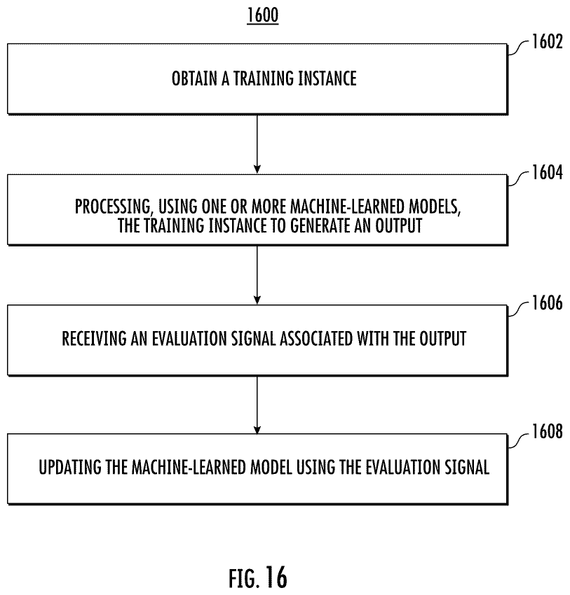

FIG. 16 depicts a flowchart of a method 1600 for training one or more machine-learned models according to aspects of the present disclosure. For instance, an example machine-learned model can include machine-learned media asset generation pipeline, machine-learned content item generation pipeline, a machine-learned text generator, a machine-learned image generator, a machine-learned audio generator, and a machine-learned video generator.

One or more portion(s) of example method 1600 can be implemented by a computing system that includes one or more computing devices such as, for example, computing systems described with reference to the other figures. Each respective portion of example method 1600 can be performed by any (or any combination) of one or more computing devices. Moreover, one or more portion(s) of example method 1600 can be implemented on the hardware components of the device(s) described herein, for example, to train one or more systems or models. FIG. 16 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 16 is described with reference to elements/terms described with respect to other systems and figures for exemplary illustrated purposes and is not meant to be limiting. One or more portions of example method 1600 can be performed additionally, or alternatively, by other systems.

At 1602, example method 1600 can include obtaining a training instance. A set of training data can include a plurality of training instances divided between multiple datasets (e.g., a training dataset, a validation dataset, or testing dataset). A training instance can be labeled or unlabeled. Although referred to in example method 1600 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 1604, example method 1600 can include processing, using one or more machine-learned models, the training instance to generate an output. The output can be directly obtained from the one or more machine-learned models or can be a downstream result of a chain of processing operations that includes an output of the one or more machine-learned models.

At 1606, example method 1600 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 1608, example method 1600 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1600 can include implementing a number of generalization techniques (e.g., weight decays, dropouts, etc.) to improve the generalization capability of the models being trained.

In some implementations, example method 1600 can be implemented for training a machine-learned model from an initialized state to a fully trained state (e.g., when the model exhibits a desired performance profile, such as based on accuracy, precision, recall, etc.).

In some implementations, example method 1600 can be implemented for particular stages of a training procedure. For instance, in some implementations, example method 1600 can be implemented for pre-training a machine-learned model. Pre-training can include, for instance, large-scale training over potentially noisy data to achieve a broad base of performance levels across a variety of tasks/data types. In some implementations, example method 1600 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

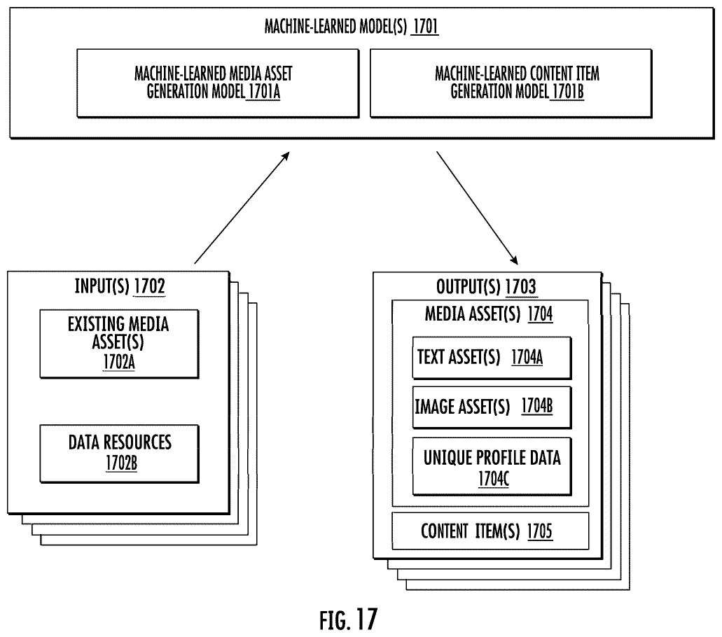

FIG. 17 is a block diagram of an example processing flow for using machine-learned model(s) 1701 701 to process input(s) 1702 to generate output(s) 1703.

Machine-learned model(s) 1701 can be or include one or multiple machine-learned models or model components. For instance, machine-learned model(s) 1701 701 can include machine-learned media asset generation model 1701A and/or machine-learned content item generation model 1701B. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1701 can include a single or multiple instances of the same model configured to operate on data from input(s) 1702. Machine-learned model(s) 1701 can include an ensemble of different models that can cooperatively interact to process data from input(s) 1702. For example, machine-learned model(s) 1701 701 can employ a mixture-of-experts structure. See, e.g., Zhou et al., Mixture-of-Experts with Expert Choice Routing, ARXIV:2202.09368v2 (Oct. 14, 2022).

Input(s) 1702 can generally include or otherwise represent various types of data. Input(s) 1702 can include one type or many different types of data. For instance, inputs can include existing media asset(s) 1702A (e.g., existing content items) and/or data resources 1702B. Output(s) 1703 can be data of the same type(s) or of different types of data as compared to input(s) 1702. Output(s) 1703 can include one type or many different types of data. For instance, output(s) 1703 can include media asset(s) 1704 and/or content item(s) 1705. Media asset(s) 1704 can include, for example, text asset(s) 1704A, image asset(s) 1704B, and/or unique profile data 1704C.

Example data types for input(s) 1702 or output(s) 1703 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 1702 or outputs 1703, example combinations of data types include image data and audio data, image data and natural language data, natural language data and software code data, image data and biometric data, sensor data and medical data, etc. It is to be understood that any combination of data types in an input 1702 or an output 1703 can be present.

An example input 1702 can include one or multiple data types, such as the example data types noted above. An example output 1703 can include one or multiple data types, such as the example data types noted above. The data type(s) of input 1702 can be the same as or different from the data type(s) of output 1703. It is to be understood that the example data types noted above are provided for illustrative purposes only. Data types contemplated within the scope of the present disclosure are not limited to those examples noted above.

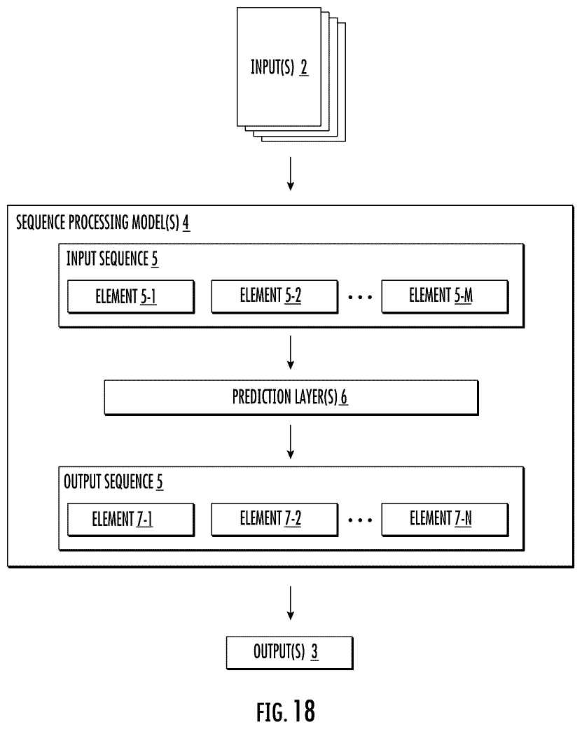

FIG. 18 is a block diagram of an example implementation of an example machine-learned model configured to process sequences of information. For instance, an example implementation of machine-learned model(s) 1701 can include machine-learned sequence processing model(s) 4. An example system can pass input(s) 1702 to sequence processing model(s) 4. Sequence processing model(s) 4 can include one or more machine-learned components. Sequence processing model(s) 4 can process the data from input(s) 1702 to obtain an input sequence 5. Input sequence 5 can include one or more input elements 5-1, 5-2, . . . , 5-M, etc. obtained from input(s) 1702. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 1703 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 1702. For instance, input sequence 5 can include a representation of data from input(s) 1702 in a format understood by sequence processing model(s) 4. One or more machine-learned components of sequence processing model(s) 4 can ingest the data from input(s) 1702, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 1702 and parse the data into a sequence of elements to obtain input sequence 5. For example, a portion of input data from input(s) 1702 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 18 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of _.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multilayer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

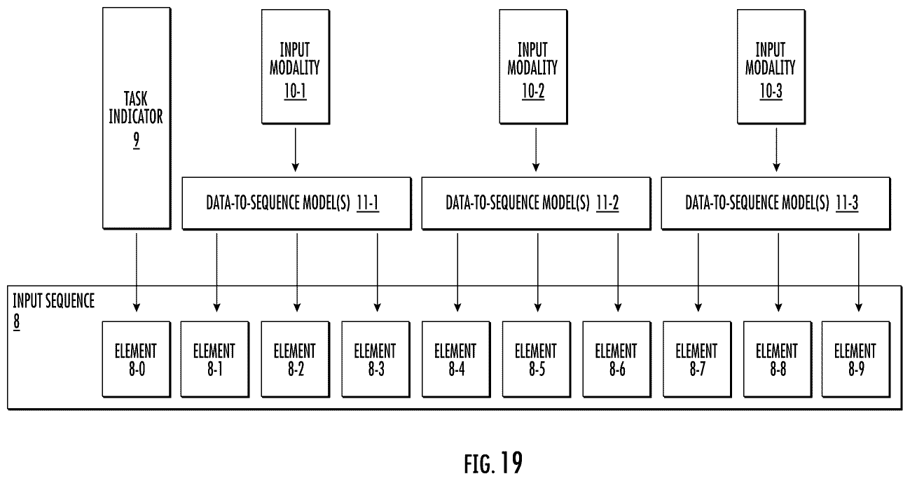

FIG. 19 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 1702 and output(s) 1703).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

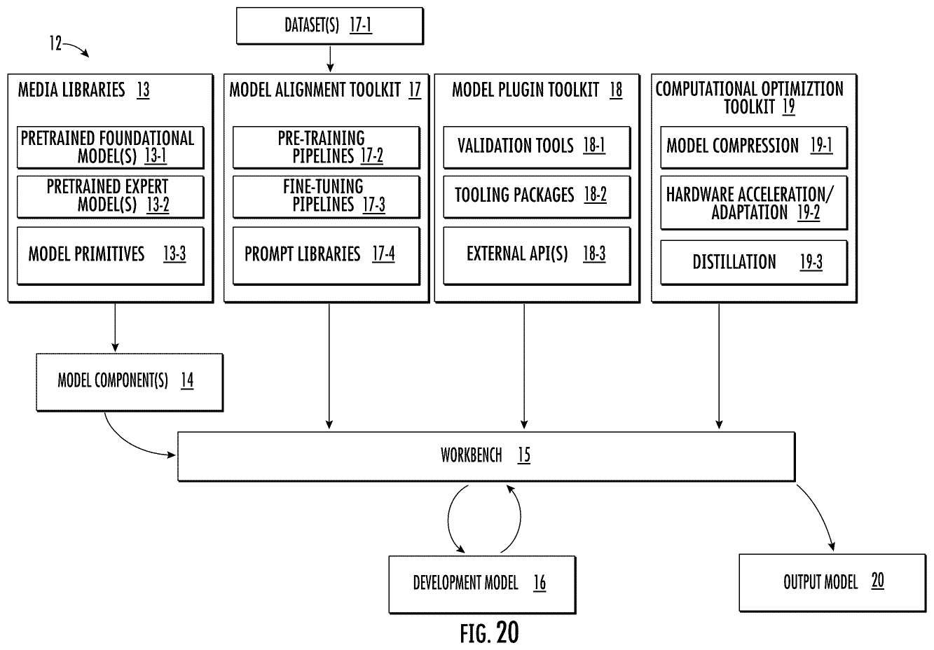

FIG. 20 is a block diagram of an example model development platform 12 that can facilitate creation, adaptation, and refinement of example machine-learned models (e.g., machine-learned model(s) 1701, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 1600 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

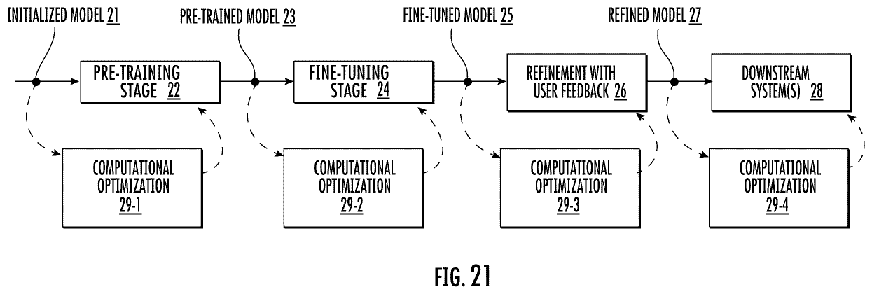

FIG. 21 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 21 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 21 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

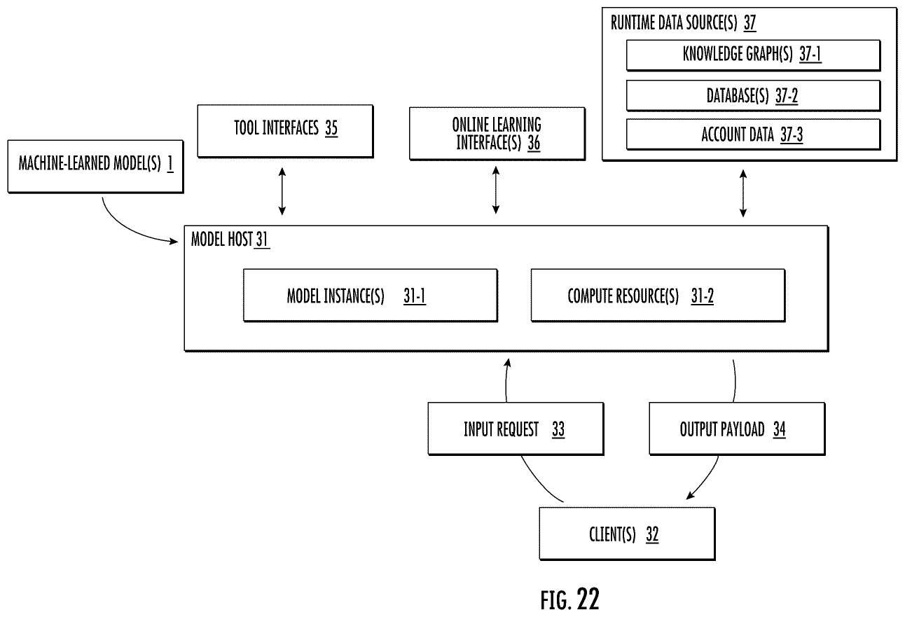

FIG. 22 is a block diagram of an inference system for operating one or more machine-learned model(s) 1701 to perform inference (e.g., for training, for deployment, etc.). A model host 31 can receive machine-learned model(s) 1701. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 1702 for input to machine-learned model(s) 1701. Machine-learned model(s) 1 can process input(s) 1702 to generate output(s) 1703. Using output(s) 1703, model host 31 can return an output payload 34 for responding to input request 33 from client(s) 32. Output payload 34 can include or be based on output(s) 1703.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1701. For instance, online learning interface(s) 36 can be used within reinforcement learning loops to retrieve user feedback on inferences served by model host 31. Model host 31 can access runtime data source(s) 37 for augmenting input(s) 1702 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 1702. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 1702. Model host 31 can process input request 33 to obtain input(s) 1702. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 1702 can be distributed across the batch dimension (e.g., rows of an array). The separate input(s) 1702 can include completely different contexts. The separate input(s) 1702 can be multiple inference steps of the same task. The separate input(s) 1702 can be staggered in an input structure, such that any given inference cycle can be operating on different portions of the respective input(s) 1702. In this manner, for instance, model host 31 can perform inference on the batch in parallel, such that output(s) 1703 can also contain the batch dimension and return the inference results for the batched input(s) 1702 in parallel. In this manner, for instance, batches of input request(s) 33 can be processed in parallel for higher throughput of output payload(s) 34.

Output payload 34 can include or be based on output(s) 1703 from machine-learned model(s) 1701. Model host 31 can process output(s) 1703 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1701. Online learning interface(s) 36 can facilitate reinforcement learning with human feedback (RLHF). Online learning interface(s) 36 can facilitate federated learning of machine-learned model(s) 1701.

Model host 31 can execute machine-learned model(s) 1701 to perform inference for various tasks using various types of data. For example, various different input(s) 1702 and output(s) 1703 can be used for various different tasks. In some implementations, input(s) 1702 can be or otherwise represent image data. Machine-learned model(s) 1 can process the image data to generate an output. As an example, machine-learned model(s) 1701 can process the image data to generate an image recognition output (e.g., a recognition of the image data, a latent embedding of the image data, an encoded representation of the image data, a hash of the image data, etc.). As another example, machine-learned model(s) 1701 can process the image data to generate an image segmentation output. As another example, machine-learned model(s) 1701 can process the image data to generate an image classification output. As another example, machine-learned model(s) 1701 can process the image data to generate an image data modification output (e.g., an alteration of the image data, etc.). As another example, machine-learned model(s) 1701 can process the image data to generate an encoded image data output (e.g., an encoded and/or compressed representation of the image data, etc.). As another example, machine-learned model(s) 1701 can process the image data to generate an upscaled image data output. As another example, machine-learned model(s) 1701 can process the image data to generate a prediction output.

In some implementations, the task is a computer vision task. In some cases, input(s) 1702 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 1702 can be or otherwise represent natural language data. Machine-learned model(s) 1 can process the natural language data to generate an output. As an example, machine-learned model(s) 1701 can process the natural language data to generate a language encoding output. As another example, machine-learned model(s) 1701 can process the natural language data to generate a latent text embedding output. As another example, machine-learned model(s) 1701 can process the natural language data to generate a translation output. As another example, machine-learned model(s) 1701 can process the natural language data to generate a classification output. As another example, machine-learned model(s) 1701 can process the natural language data to generate a textual segmentation output. As another example, machine-learned model(s) 1701 can process the natural language data to generate a semantic intent output. As another example, machine-learned model(s) 1701 can process the natural language data to generate an upscaled text or natural language output (e.g., text or natural language data that is higher quality than the input text or natural language, etc.). As another example, machine-learned model(s) 1701 can process the natural language data to generate a prediction output (e.g., one or more predicted next portions of natural language content).

In some implementations, input(s) 1702 can be or otherwise represent speech data (e.g., data describing spoken natural language, such as audio data, textual data, etc.). Machine-learned model(s) 1 can process the speech data to generate an output. As an example, machine-learned model(s) 1701 can process the speech data to generate a speech recognition output. As another example, machine-learned model(s) 1701 can process the speech data to generate a speech translation output. As another example, machine-learned model(s) 1701 can process the speech data to generate a latent embedding output. As another example, machine-learned model(s) 1701 can process the speech data to generate an encoded speech output (e.g., an encoded and/or compressed representation of the speech data, etc.). As another example, machine-learned model(s) 1701 can process the speech data to generate an upscaled speech output (e.g., speech data that is higher quality than the input speech data, etc.). As another example, machine-learned model(s) 1701 can process the speech data to generate a textual representation output (e.g., a textual representation of the input speech data, etc.). As another example, machine-learned model(s) 1701 can process the speech data to generate a prediction output.

In some implementations, input(s) 1702 can be or otherwise represent latent encoding data (e.g., a latent space representation of an input, etc.). Machine-learned model(s) 1 can process the latent encoding data to generate an output. As an example, machine-learned model(s) 1701 can process the latent encoding data to generate a recognition output. As another example, machine-learned model(s) 1701 can process the latent encoding data to generate a reconstruction output. As another example, machine-learned model(s) 1701 can process the latent encoding data to generate a search output. As another example, machine-learned model(s) 1701 can process the latent encoding data to generate a reclustering output. As another example, machine-learned model(s) 1701 can process the latent encoding data to generate a prediction output.

In some implementations, input(s) 1702 can be or otherwise represent statistical data. Statistical data can be, represent, or otherwise include data computed and/or calculated from some other data source. Machine-learned model(s) 1 can process the statistical data to generate an output. As an example, machine-learned model(s) 1701 can process the statistical data to generate a recognition output. As another example, machine-learned model(s) 1701 can process the statistical data to generate a prediction output. As another example, machine-learned model(s) 1701 can process the statistical data to generate a classification output. As another example, machine-learned model(s) 1701 can process the statistical data to generate a segmentation output. As another example, machine-learned model(s) 1701 can process the statistical data to generate a visualization output. As another example, machine-learned model(s) 1701 can process the statistical data to generate a diagnostic output.

In some implementations, input(s) 1702 can be or otherwise represent sensor data. Machine-learned model(s) 1 can process the sensor data to generate an output. As an example, machine-learned model(s) 1701 can process the sensor data to generate a recognition output. As another example, machine-learned model(s) 1701 can process the sensor data to generate a prediction output. As another example, machine-learned model(s) 1701 can process the sensor data to generate a classification output. As another example, machine-learned model(s) 1701 can process the sensor data to generate a segmentation output. As another example, machine-learned model(s) 1701 can process the sensor data to generate a visualization output. As another example, machine-learned model(s) 1701 can process the sensor data to generate a diagnostic output. As another example, machine-learned model(s) 1701 can process the sensor data to generate a detection output.

In some implementations, machine-learned model(s) 1701 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1701 can be configured to output content generated in view of input(s) 1702. For instance, input(s) 1702 can be or otherwise represent data of one or more modalities that encodes context for generating additional content.

In some implementations, the task can be a text completion task. Machine-learned model(s) 1 can be configured to process input(s) 1702 that represent textual data and to generate output(s) 1703 that represent additional textual data that completes a textual sequence that includes input(s) 1702. For instance, machine-learned model(s) 1701 can be configured to generate output(s) 1703 to complete a sentence, paragraph, or portion of text that follows from a portion of text represented by input(s) 1702.

In some implementations, the task can be an instruction following task. Machine-learned model(s) 1 can be configured to process input(s) 1702 that represent instructions to perform a function and to generate output(s) 1703 that advance a goal of satisfying the instruction function (e.g., at least a step of a multi-step procedure to perform the function). Output(s) 3 can represent data of the same or of a different modality as input(s) 1702. For instance, input(s) 1702 can represent textual data (e.g., natural language instructions for a task to be performed) and machine-learned model(s) 1701 can process input(s) 1702 to generate output(s) 1703 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1701 can process input(s) 1702 to generate output(s) 1703 that represent textual data responsive to the instructions (e.g., natural language responses, programming language responses, machine language responses, etc.). One or more output(s) 1703 can be iteratively or recursively generated to sequentially process and accomplish steps toward accomplishing the requested functionality. For instance, an initial output can be executed by an external system or be processed by machine-learned model(s) 1701 to complete an initial step of performing a function. Multiple steps can be performed, with a final output being obtained that is responsive to the initial instructions.

In some implementations, the task can be a question answering task. Machine-learned model(s) 1 can be configured to process input(s) 1702 that represent a question to answer and to generate output(s) 1703 that advance a goal of returning an answer to the question (e.g., at least a step of a multi-step procedure to perform the function). Output(s) 3 can represent data of the same or of a different modality as input(s) 1702. For instance, input(s) 1702 can represent textual data (e.g., natural language instructions for a task to be performed) and machine-learned model(s) 1701 can process input(s) 1702 to generate output(s) 1703 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1701 can process input(s) 1702 to generate output(s) 1703 that represent textual data responsive to the question (e.g., natural language responses, programming language responses, machine language responses, etc.). One or more output(s) 1703 can be iteratively or recursively generated to sequentially process and accomplish steps toward answering the question. For instance, an initial output can be executed by an external system or be processed by machine-learned model(s) 1701 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 1702 that represent context regarding a desired portion of image content. The context can include text data, image data, audio data, etc. Machine-learned model(s) 1 can be configured to generate output(s) 1703 that represent image data that depicts imagery related to the context. For instance, machine-learned model(s) 1701 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 1702 that represent context regarding a desired portion of audio content. The context can include text data, image data, audio data, etc. Machine-learned model(s) 1 can be configured to generate output(s) 1703 that represent audio data related to the context. For instance, machine-learned model(s) 1701 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 1702 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 1703 that represent data that aligns with the desired data. For instance, machine-learned model(s) 1701 can be configured to generate data values for populating a dataset. Values for the data object(s) can be selected based on the context (e.g., based on a probability determined based on the context).

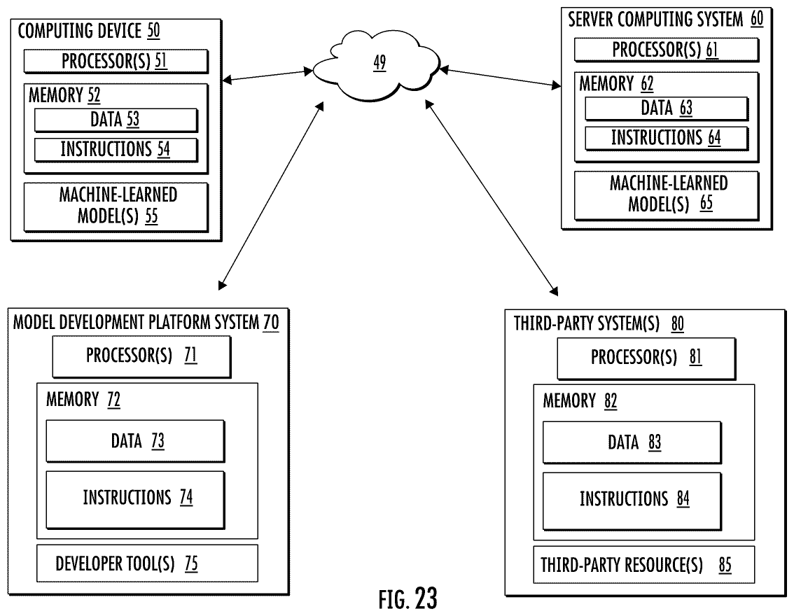

FIG. 23 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 23 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1701, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1701, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1701, 4, 16, 20, 55, 65, etc. (e.g., third-party resource(s) 85).

FIG. 23 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

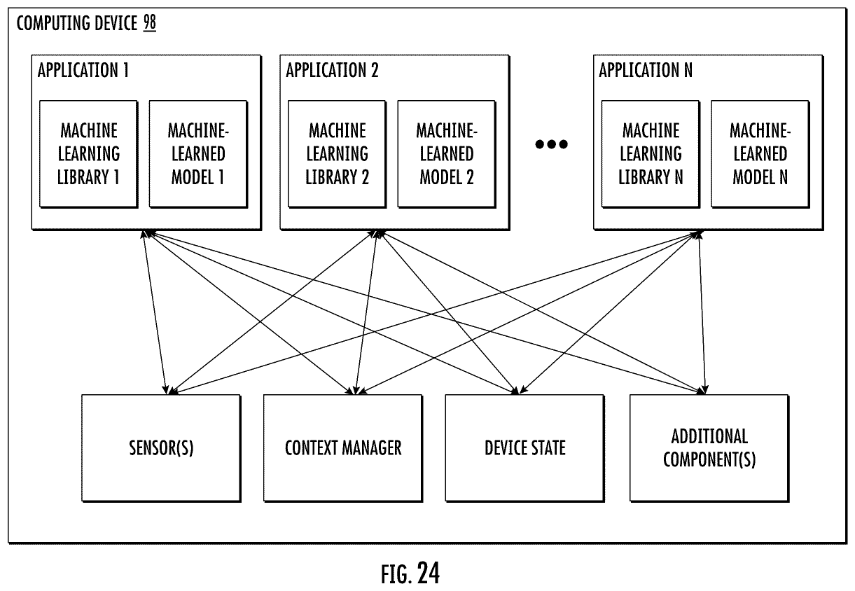

FIG. 24 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 24, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

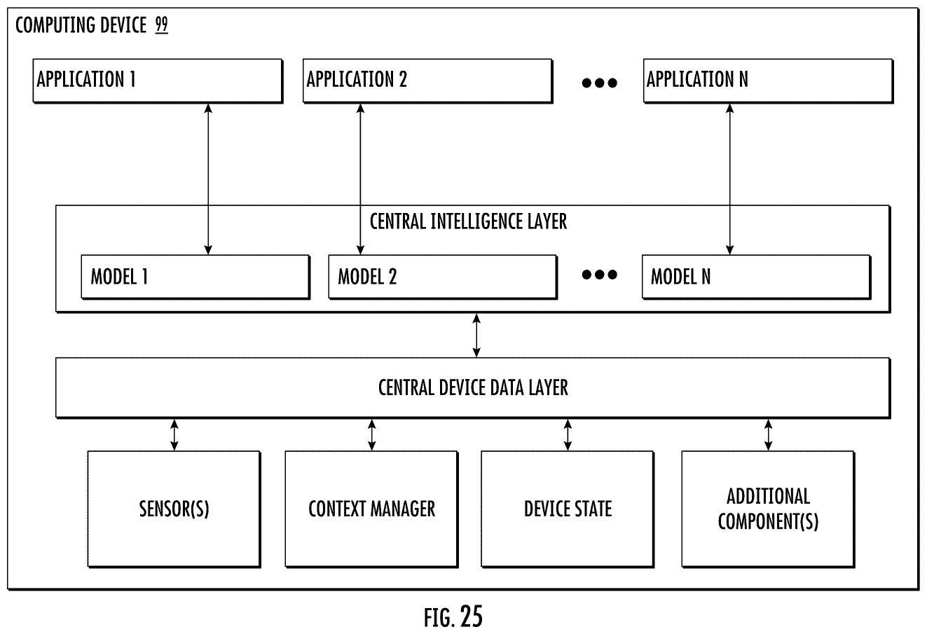

FIG. 25 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 25, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 25, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

1. A computer-implemented method comprising:
receiving data indicating a request for a plurality of media assets that comprise a plurality of media modalities to be generated based on a pre-existing media asset;
generating a plurality of media asset components by:
(i) extracting, from the pre-existing media asset, one or more signals comprising at least one of background image data, color palette data, text data, or logo image data;
(ii) generating, using a first generative machine-learned model, a plurality of background image assets by:
generating, based on at least one of the background image data, the text data, or the logo image data, a mask image comprising one or more bounding boxes;
inpainting the mask image by generating, using a machine-learned model, pixels to fill the one or more bounding boxes of the mask image;
generating a plurality of images, wherein each image comprises distinct aspect ratio;
(iii) generating, using a second generative machine-learned model, a plurality of text assets by:
obtaining the text data associated with the one or more bounding boxes;
inputting the text data into a machine-learned model;
generating, by the machine-learned model a plurality of text assets as output; and
(iv) generating, using a third generative machine-learned model, unique profile data based on at least one of the color palette data or the logo image data; and
automatically transmitting the plurality of media assets comprising one or more image assets, text assets, and unique profile data to a content item generation pipeline for generating a plurality of candidate content items.

2. The computer-implemented method of any claim 1, wherein generating the mask image comprising one or more bounding boxes comprises:
identifying one or more text objects;
for each text object of the one or more text objects:
determining that a first text object of the one or more text objects is an overlay text object; and
based on determining that the first object is an overlay text object, generating a first bounding box for the first text object.

3. The computer-implemented method of claim 1, wherein generating the plurality of media asset components comprises:
extracting logo image;
selecting a dominant color from an image color palette;
upscaling the logo image by:
enlarging the logo image; and
sharpening the logo image; and
generatively expanding the logo image to generate one or more images, wherein each image comprises a different set of aspect ratios.

4. The computer-implemented method of claim 3, wherein generatively expanding the logo image comprises: generating pixels to blend with existing pixels of the logo image to generate a larger image than the original logo image.

5. The computer-implemented method of claim 1, wherein generating the plurality of background image assets comprises adjusting at least one of a brightness, saturation, or contrast of the respective background image assets.

6. The computer-implemented method of claim 1, wherein the unique profile data comprises at least one of logo data, color palette data, font data, or image styling data.

7. The computer-implemented method of claim 1, comprising:
inputting the plurality of output assets into a content creation pipeline; and
generating, by the content creation pipeline, a plurality of content items, wherein each content item of the plurality of content items comprises a unique combination of content assets and aspect ratios.

8. The computer-implemented method of claim 1, wherein generating the plurality of text assets comprises:
extracting signals comprising text data;
compiling the text data;
inputting the compiled text data into the second generative machine-learned model;
obtaining at least one of short headlines or long headlines as output from the second generative machine-learned model;
inputting at least one of the short headlines or long headlines into the second generative machine-learned model; and
obtaining, as output from the machine-learned model, descriptions.

9. The computer-implemented method of claim 1, wherein the one or more bounding boxes comprises a location and size of a bounding box.

10. The computer-implemented method of claim 1, wherein the content item generation pipeline comprises a prompt generation component and a content item generation component.

11. The computer-implemented method of claim 10, comprising:
generating, by the prompt generation component, an input prompt data based on the background images, the text assets, and the unique profile data;
providing the input prompt data to the content item generation component; and
generating, by the content item generation component, one or more candidate content items based on the input prompt data.

12. The computer-implemented method of claim 10, wherein the content item generation component comprises a generative machine-learned model.

13. The computer-implemented method of claim 12, comprising:
training the generative machine-learned model by:
generating a training data set based on comparing a generated content item component to an existing media asset; and
based on comparing the generated content item component to the existing media asset, automatically adjusting one or more parameters of the generative machine-learned model to reduce a difference in the generated content item and the existing media asset.

14. A computing system comprising:
one or more processors; and
one or more transitory computer-readable media storing instructions that are executable to cause the one or more processors to perform operations, the operations comprising:
receiving data indicating a request for a plurality of media assets that comprise a plurality of media modalities to be generated based on a pre-existing media asset;
generating a plurality of media asset components by:
(i) extracting one or more signals comprising at least one of background image data, color palette data, text data, or logo image data;
(ii) generating, using a first generative machine-learned model, a plurality of background image assets based on at least one of the background image data, the text data, the logo image data or the color palette data;
(iii) generating, using a second generative machine-learned model, a plurality of text assets based on at least one of the text data or background image data;
(iv) generating, using a third generative machine-learned model, unique profile data based on at least one of color palette data, text data, or logo image data; and
automatically transmitting the plurality of media assets comprising one or more image assets, text assets, and unique profile data to a content item generation pipeline for generating a plurality of candidate content items.

15. The computing system of claim 14, the operations comprising:
receiving data indicative of the pre-existing media asset being uploaded.

16. The computing system of claim 14, the operations comprising:
parsing a web resource associated with unique profile data to obtain the pre-existing media asset.

17. The computing system of claim 14, wherein the pre-existing media asset comprises flattened image data.

18. The computing system of claim 17, wherein the request is associated with a client account, and wherein the client account is associated with an account profile storing inputs to a machine-learned media asset generation pipeline.

19. The computing system of claim 18, wherein the profile was retrieved from a database, and wherein the profile was previously generated prior to the request.

20. One or more transitory computer readable media storing instructions that are executable by one or more processors to perform operations comprising:
receiving data indicating a request for a plurality of media assets that comprise a plurality of media modalities to be generated based on a pre-existing media asset;
generating a plurality of media asset components by:
(i) extracting one or more signals comprising at least one of background image data, color palette data, text data, or logo image data;
(ii) generating, using a first generative machine-learned model, a plurality of background image assets based on at least one of the background image data, the text data, the logo image data or the color palette data;
(iii) generating, using a second generative machine-learned model, a plurality of text assets based on at least one of the text data or background image data;
(iv) generating, using a third generative machine-learned model, unique profile data based on at least one of color palette data, text data, or logo image data; and
automatically transmitting the plurality of media assets comprising one or more image assets, text assets, and unique profile data to a content item generation pipeline for generating a plurality of candidate content items.
